(19) United States
(12) Patent Application Publication
(10) Pub. No.: US 2009/0061346 A1
(43) Pub. Date: Mar. 5, 2009

(54) Liquid Developer and Image Forming Apparatus

(75) Inventor: Toshiaki YAMAGAMI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/187,754

(22) Filed: Aug. 7, 2008

(30) Foreign Application Priority Data
Aug. 30, 2007 (JP) 2007-224842

(51) Int. Cl. G03G 9/125; G03G 9/13; G03G 15/10

(52) U.S. Cl. 430/114; 430/116; 399/237

(57) ABSTRACT

A liquid developer includes an insulating liquid containing a fatty acid monoester and a toner particle constituted mainly of a resin material, the main toner particle being shaped in a disc form.

### BACKGROUND

1. Technical Field

The present invention relates to a liquid developer and an image forming apparatus using the same.

2. Related Art

A developer which is used for developing an electrostatic latent image formed on a latent image carrier includes a dry toner in which a toner particle constituted of a material containing a coloring agent such as pigments and a binder resin is used in a dry state together with an external additive; and a liquid developer (liquid toner) in which a toner particle is dispersed in an electrically insulating carrier liquid (insulating liquid).

A method of using a dry toner is advantageous in treatment because a toner in a solid state is treated. However, it involves problems that in addition to fear of adverse influences by the powder against human bodies and the like, staining due to scattering of the toner and coagulation of the toner particle are easy to occur, it is difficult to make the size of the toner particle thoroughly small, and it is difficult to form an toner image with a high resolution. In the case where the size of the toner particle is made relatively small, the foregoing problems to be caused due to the matter that the toner is a powder become further remarkable.

On the other hand, according to a method of using a liquid developer, since coagulation of the toner particle in the liquid developer is effectively prevented, it is possible to use a fine toner particle, and a resin material having a lower softening point (lower softening temperature) than that to be used in the dry toner can be used as the binder resin. As a result, the method of using a liquid developer has characteristic features that reproducibility of a fine line image is good; gradation reproducibility is good; color reproducibility is excellent; and it is also excellent as an image forming method at a high speed.

However, the insulating liquid which has hitherto been used in the liquid developer is one composed mainly of a petroleum based hydrocarbon. In such a liquid developer, the insulating liquid is deposited on the surface of the toner particle during fixing. According to the related-art liquid developers, the fix level is lowered due to the presence of this insulating liquid deposited on the surface of the toner particle, whereby a sufficiently satisfactory fixing characteristic could not be obtained.

In order to solve these problems, there is made an attempt to enhance the fix level using, as the insulating liquid, one containing a fatty acid monoester or a fatty acid glyceride (see, for example, JP-A-2006-251252 and JP-A-2007-41161).

However, the foregoing liquid developer using an insulating liquid involved a problem that though the fix level is enhanced, sufficient gloss on an image to be formed is not obtainable.

### SUMMARY

An advantage of some aspects of the invention is to provide a liquid developer being environmentally friendly, having excellent low-temperature fixability and capable of forming an image with excellent gloss and to provide an image forming apparatus using such a liquid developer.

A liquid developer according to a first aspect of the invention includes an insulating liquid containing a fatty acid monoester and a toner particle constituted mainly of a resin material, the main toner particle being shaped in a disc form.

In the liquid developer according to the first aspect of the invention, it is preferable that when an average diameter in the major axis direction and an average diameter in the minor axis direction of the toner particle are defined as X (μm) and Y (μm), respectively, a relationship of (0.05≦Y/X≦0.7) is satisfied.

In the liquid developer according to the first aspect of the invention, it is preferable that the average diameter in the major axis direction of the toner particle is from 1 to 10 μm.

In the liquid developer according to the first aspect of the invention, it is preferable that the average diameter in the minor axis direction of the toner particle is from 0.1 to 4 μm.

In the liquid developer according to the first aspect of the invention, it is preferable that the fatty acid monoester is one containing a fatty acid having from 8 to 22 carbon atoms as a fatty acid component.

In the liquid developer according to the first aspect of the invention, it is preferable that the fatty acid monoester is one containing an alcohol component having from 1 to 4 carbon atoms.

In the liquid developer according to the first aspect of the invention, it is preferable that the content of the fatty acid monoester in the insulating liquid is from 1.0 to 50% by weight.

In the liquid developer according to the first aspect of the invention, it is preferable that the insulating liquid is one containing a fatty acid triglyceride.

In the liquid developer according to the first aspect of the invention, it is preferable that a solid obtained by removing the insulating liquid has a Tg measured by DSC of from 15 to 35° C.

In the liquid developer according to the first aspect of the invention, it is preferable that the resin material is one containing a polyester resin.

An image forming apparatus according to a second aspect of the invention includes plural development parts for forming a monochromic image corresponding to each color using plural liquid developers having a different color; an intermediate transfer part for forming an intermediate transferred image to be formed by successively transferring the plural monochromic images formed in the plural development parts and superimposing the plural transferred monochromic images; a secondary transfer part for transferring the intermediate transferred image onto a recording medium to form an unfixed color image on the recording medium; and a fixing part for fixing the unfixed color image onto the recording medium, the liquid developer including an insulating liquid containing a fatty acid monoester and a toner particle constituted mainly of a resin material, and the toner particle having a transverse cross section in a substantially elliptical shape and a longitudinal cross section in a substantially circular shape.

When the foregoing configurations are met, it is possible to provide a liquid developer which is environmentally friendly, is excellent in low-temperature fixability and is able to form an image with excellent gloss and to provide an image forming apparatus using such a liquid developer.

### BRIEF DESCRIPTION OF THE DRAWINGS

The invention will be described with reference to the accompanying drawings, wherein like numbers reference like elements.

FIGS. 1A to 1C are each a view three-dimensionally showing the shape of a toner particle to be contained in a liquid developer according to an embodiment of the invention.

FIGS. 2A and 2B are each a drawing for explaining how to determine a softening temperature, in which FIG. 2A is a side cross-sectional view schematically illustrating a device for the measurement, and FIG. 2B is a graph for explaining a method for determining a softening temperature (T1/2) from the measurement results.

FIG. 3 is a schematic view illustrating an embodiment of an image forming apparatus to which a liquid developer according to an embodiment of the invention is applied.

FIG. 4 is an enlarged view enlarging a part of the image forming apparatus as illustrated in FIG. 3.

FIG. 5 is a schematic view illustrating the state of a toner particle in a liquid developer layer on a developing roller.

FIG. 6 is a cross-sectional view illustrating an embodiment of a fixing device to be applied to the image forming apparatus as illustrated in FIG. 3.

FIG. 7 is a photograph substituted for drawing through observation of a toner particle to be contained in a liquid developer prepared in Example 1 by a scanning electron microscope (SEM).

FIG. 8 is a photograph substituted for drawing through observation of a toner particle to be contained in a liquid developer prepared in Comparative Example by a scanning electron microscope (SEM).

### DESCRIPTION OF EXEMPLARY EMBODIMENTS

Preferred embodiments of the invention are hereunder described in detail.

### Liquid Developer:

The liquid developer of the invention is one having a toner particle dispersed in an insulating liquid.

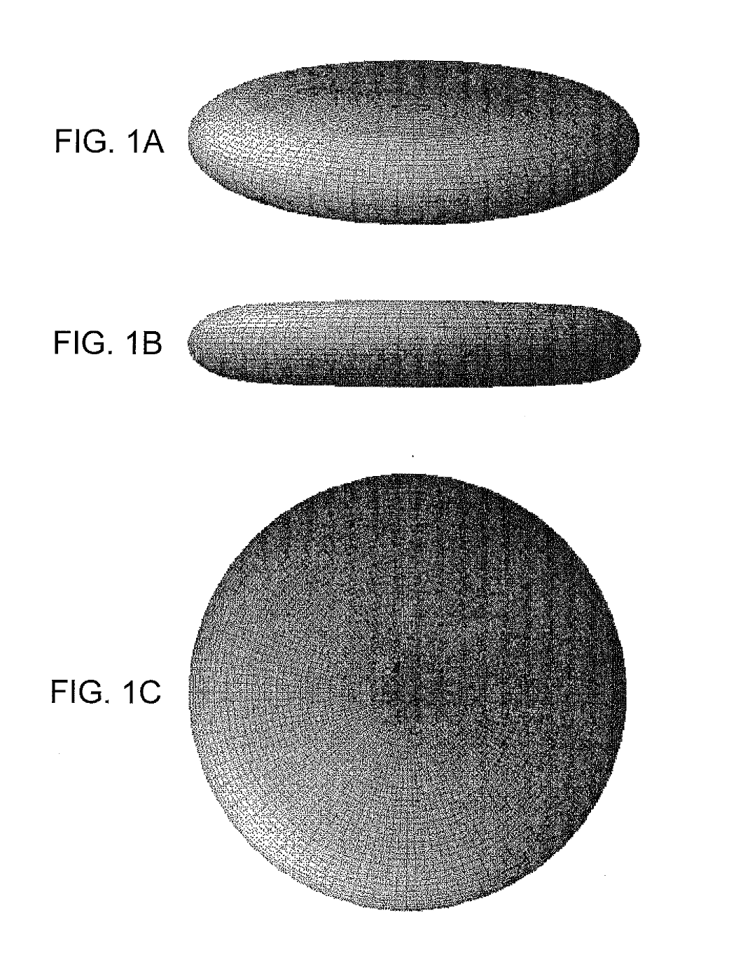

FIGS. 1A to 1C are each a view three-dimensionally showing the shape of a toner particle to be contained in a liquid developer of the invention, in which FIG. 1A is a view seen from diagonally above; FIG. 1B is a view seen from the side; and FIG. 1C is a view seen from above.

### Toner Particle:

First of all, the toner particle is described.

### Shape of Toner Particle:

First of all, the shape of the toner particle is described.

In the invention, the toner particle is shaped in a disc form. That is, the toner particle has a shape as illustrated in FIGS. 1A to 1C and as illustrated in FIGS. 1A and 1B, has a flat portion in the center and has a shape in which an edge part has a curvature. As illustrated in FIG. 1C, the toner particle is shaped such that its planar view from the thickness direction (minor axis direction) is a substantially circular form.

During the transfer onto a recording medium, the toner particle of such a shape exhibits a tendency that the toner particle stands in line such that the minor axis side thereof (lower side in FIG. 1B) is faced at the surface of the recording medium. For that reason, a formed image follows irregularities of the recording medium. As a result, it is possible to make the formed image excellent such that unevenness in gloss to be caused due to the presence or absence or the amount of deposition of the toner is a little. In particular, as described later in detail, in the liquid developer of the invention, since the insulating liquid is one containing a fatty acid monoester, the toner particle is satisfactorily plasticized, whereby the toner particle is easy to get into gaps among fibers of the recording medium. As a result, the formed image more likely follows the fibers, whereby gloss of the formed image becomes especially excellent. The plasticization by the fatty acid monoester is described below in detail.

As described previously, during the transfer onto a recording medium, the toner particle shaped in a disc form exhibits a tendency that the toner particle stands in line such that the minor axis side thereof (upper side or lower side in FIG. 1B) is faced at the surface of the recording medium. Therefore, in forming an image using toner particles of plural colors, even in the case where the toner particles having a different color are superimposed, a layer of the toner particles on the recording medium can be made relatively thin. As a result, it is possible to make a formed image follow irregularities of the recording medium and to make the gloss of the formed image excellent.

In comparison with a spherical toner particle, the toner particle having such a shape is easy to conduct heat to the inside and furthermore, is plasticized with a fatty acid monoester as described later. Therefore, even by shortening the fixing time and making the quantity of heat relatively small, the toner particle can be surely melted. According to this, it is possible to achieve fixing in a small quantity of heat and to devise to realize higher speed of the image formation and energy saving. In the case where toner particles having a different color are superimposed, since the toner particles having a different color are surely mixed with each other, the color developability becomes satisfactory.

It is preferable that when an average diameter in the major axis direction (vertical direction in FIG. 1B) and an average diameter in the minor axis direction (horizontal direction in FIG. 1B) of the toner particle are defined as X (μm) and Y (μm), respectively, a relationship of (0.05≦Y/X≦0.7) is satisfied. It is more preferable that a relationship of (0.1≦Y/X≦0.6) is satisfied. When such a relationship is satisfied, the toner particle is easy to stand in line such that the minor axis side thereof (lower side in FIG. 1B) is faced at the surface of the recording medium. It is also possible to make the plasticization with a fatty acid monoester as described later more remarkable. As a result, it is possible to make the formed image flat more effectively and to make the gloss of the formed image more excellent. On the other hand, when the Y/X value is too small, the removal of a carrier is difficult so that the developability may be possibly influenced. When the Y/X value is too large, there may be the case where it is difficult to plasticize the toner particle.

Specifically, the average diameter in the major axis direction of the toner particle is preferably from 1 to 10 μm, and more preferably from 2 to 7 μm. According to this, it is possible to minimize scattering in characteristics between the respective toner particles and to make a resolution of the formed image by the liquid developer sufficiently high while enhancing reliability as the whole of the liquid developer.

The average diameter in the major axis direction of the toner particle is preferably from 0.1 to 4 μm, and more preferably from 0.3 to 2 μm. According to this, not only the toner particle stands more easily in line such that the minor axis side thereof (lower side in FIG. 1B) is faced at the surface of the recording medium, but it is possible to make the plasticization with a fatty acid monoester as described later more remarkable.

The content of the toner particle in the liquid developer is preferably from 10 to 60% by weight, and more preferably from 20 to 50% by weight.

### Constitutional Material of Toner Particle:

The toner particle which constitutes the liquid developer of the invention is one containing at least a resin material and a coloring agent.

### 1. Resin Material:

The toner particle which constitutes the liquid developer is constituted of a material containing, as a major component, a resin material.

In the invention, the resin (binder resin) is not particularly limited, and for example, a known resin can be used. It is preferable to use a polyester resin. The polyester resin has high transparency, and when used as a binder resin, it is possible to more enhance the color developability of the obtained image. For example, in the case where one containing a fatty acid monoester as described later is used as the insulating liquid, since the polyester resin has an ester component in a molecular structure thereof likewise a fatty acid monoester, it has high compatibility with the fatty acid monoester so that it is able to make the dispersibility of the toner particle in the liquid developer especially excellent. At the time of fixing, the fatty acid monoester is easy to penetrate, a plasticizer effect as described later can be surely revealed, and the fixing characteristic can be made more excellent.

A glass transition point (Tg) of the resin material is preferably from 40 to 70° C., and a softening temperature (T1/2) thereof is preferably from 100 to 150° C. According to this, not only it is possible to make the fixing characteristic of the liquid developer at a low temperature more excellent, but it is possible to make the gloss of the formed image more excellent. It is also possible to make the shape of the toner particle more favorable. In the case where plural kinds of resins are contained as the resin component, a weighted average value of each of glass transition points and softening temperatures of the respective resins can be employed as a glass transition point and a softening temperature of the resin component.

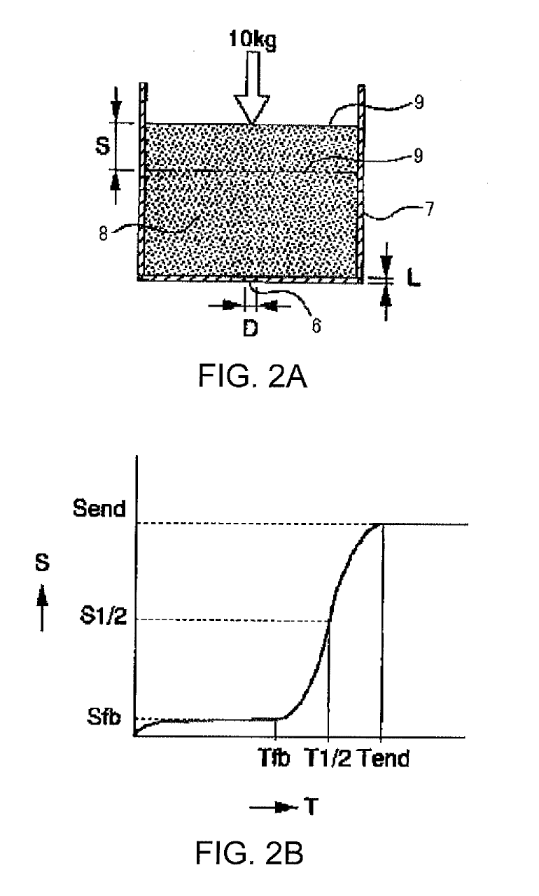

The “softening temperature (T1/2)” as referred to in this specification refers to a value determined in the following manner using a flow tester (CFT-500, manufactured by Shimadzu Corporation) which is a constant-pressure extrusion type capillary rheometer unless otherwise indicated That is, as illustrated in FIG. 2A, a sample 8 (weight: 1.5 g) is filled in a cylinder 7 having a nozzle 6 having a nozzle diameter D of 1.0 mm and a nozzle length (depth) of 1.0 mm; a load of 10 kg per unit area (cm²) is applied from the side opposing to the nozzle 6; when the sample 8 is heated in this state at a temperature rise rate of 6° C. per minute, a stroke S of a loading surface 9 (sunk value of the loading surface 9) is measured, thereby determining the relationship between the raised temperature and the stroke S as shown in FIG. 2B; and when a temperature at which the flowing out of the sample 8 from the nozzle 6 starts, the stroke S becomes large abruptly, and the curve rises is defined as Tfb (° C.), and a temperature at which the flowing out of the sample 8 from the nozzle 6 substantially terminates, and the curve lies flat is defined as Tend (° C.), a temperature at S1/2 which is an intermediate value between a stroke Sfb at Tfb and a stroke Send at Tend is employed as the softening temperature (T1/2) in this specification.

### 2. Coloring Agent:

The toner particle contains a coloring agent in the resin. The coloring agent is not particularly limited, and for example, known pigments and dyes can be used. At that time, for the purpose of dispersing in the resin, the coloring agent may contain a known dispersant.

### 3. Other Components:

The toner particle may contain components other than those described above. Examples of such components include known waxes and antistatic agents.

For example, the toner particle may contain an ester wax (for example, carnauba wax and rice wax), a hydrocarbon based wax, zinc stearate, zinc oxide, cerium oxide, silica, titanium oxide, iron oxide, a fatty acid, a fatty acid metal oxide, etc. For the purpose of dispersing in the resin, the foregoing components may be subjected to a surface treatment or may contain a dispersant.

### Insulating Liquid:

The insulating liquid is hereunder described.

In the invention, the liquid developer is formed by dispersing the toner particle in an insulating liquid. This insulating liquid contains a fatty acid monoester.

The fatty acid monoester is an environmentally friendly component. In consequence, it is possible to reduce a load of the insulating liquid to the environment to be caused due to leakage of the insulating liquid into the outside of the image forming apparatus, disposal of the used liquid developer or the like. As a result, it is possible to provide a liquid developer which is environmentally friendly.

The fatty acid monoester has an effect for plasticizing the resin material to be contained in the toner particle (plasticizer effect). Furthermore, as described previously, the toner particle to be used in the liquid developer of the invention is shaped in a disc form, and therefore, a specific surface area of the toner particle is large. According to this, the fatty acid monoester is able to sufficiently penetrate into the inside of the toner particle, and to sufficiently plasticize even the inside of the toner particle (resin material). According to this, for example, in the case where paper is used as the recording medium, the toner particle is easy to get into gaps among paper fibers, and therefore, the fixing characteristic between the paper and the toner particle becomes especially excellent. Since the plasticization sufficiently proceeds to the inside of the toner particle, the toner particle is melted even at a relatively low temperature, whereby it becomes possible to achieve fixing to the recording medium. Therefore, the toner particle can be favorably applied even to the image formation at a low temperature and a high speed. In the case where an image is formed using toner particles of plural colors, the sufficiently plasticized toner particles come into contact with each other and are melted each other, whereby it is possible to surely bind the adjacent toner particles having a different color with each other. As a result, in an area where the toner particles having a different color are bound with each other, the colors which the respective toner particles have are mixed with each other to assume an intermediate color therebetween, whereby it becomes possible to obtain more surely a desired color tone of the image. Furthermore, because of the matter that the toner particle is sufficiently plasticized to the inside thereof, the obtained toner image follows irregularities of the recording medium. As a result, the formed image is a little as to unevenness in gloss.

The fatty acid monoester is a component which is especially high in compatibility with the resin material and is easy to deposit on the surface of the toner particle. The fatty acid monoester is also a component which is easy to penetrate into the recording medium. For that reason, the fatty acid monoester deposited in the vicinity of the surface of the toner particle rapidly penetrates into the recording medium during the contact of the toner particle with the recording medium at the time of fixing. A part of the toner particle (resin material constituting the toner particle) which has been melted by heat at the time of fixing penetrates into the inside of the recording medium with the penetration of this fatty acid monoester, and an anchor effect works, whereby the fix level is enhanced.

Examples of such a fatty acid monoester include alkyl (for example, methyl, ethyl, propyl and butyl) monoesters of an unsaturated fatty acid represented by oleic acid, palmitoleic acid, linolic acid, α-linoleic acid, γ-linoleic acid, arachidonic acid, docosahexaenoic acid (DHA), eicosapentaenoic acid (EPA), etc.; and alkyl (for example, methyl, ethyl, propyl and butyl) monoesters of a saturated fatty acid represented by butyric acid, caproic acid, caprylic acid, capric acid, lauric acid, myristic acid, palmitic acid, stearic acid, arachidic acid, behenic acid, lignoceric acid, etc. One kind or a combination of two or more kinds selected among these compounds can be used.

The fatty acid monoester is a monoester between a fatty acid and an alcohol, and the alcohol is preferably an alkyl alcohol having from 1 to 4 carbon atoms. According to this, it is possible to make the insulating liquid have a favorable viscosity and to make the penetration of the liquid developer into the recording medium more favorable. Examples of such an alcohol include methanol, ethanol, propanol, butanol and isopropanol.

The fatty acid monoester may be also one formed through an ester exchange reaction between a vegetable oil and the foregoing monohydric alcohol. That is, the insulating liquid to be used in the invention may be one containing a fatty acid monoester of the foregoing fatty acid and one kind or a combination of two or more kinds selected among alcohols.

Examples of the vegetable oil to be provided for the ester exchange reaction include soybean oil, rapeseed oil, dehydrated castor oil, tung oil, safflower oil, linseed oil, sunflower oil, corn oil, cottonseed oil, sesame oil, maize oil, hempseed oil, evening primrose oil, palm oil (especially palm kernel oil), and coconut oil.

The content of the fatty acid monoester in the insulating liquid is preferably from 1.0 to 50% by weight, more preferably from 10 to 50% by weight, and further preferably from 20 to 50% by weight. When the content of the fatty acid monoester in the insulating liquid is less than the foregoing lower limit value, there may be the case where the plasticization of the toner particle with the fatty acid monoester at the time of fixing does not sufficiently occur. On the other hand, when the content of the fatty acid monoester in the insulating liquid exceeds the foregoing upper limit value, electric resistivity of the liquid developer is lowered, whereby there may be the case where a sufficient charge characteristic is not obtained. Depending upon the constitutional material of the member, there is a possibility that a member coming into contact with the liquid developer in an image forming apparatus as described later swells, whereby the life of the image forming apparatus is remarkably lowered.

The insulating liquid may contain an unsaturated fatty acid glyceride. This unsaturated fatty acid glyceride is in general a compound to be contained in a vegetable oil, is an ester (glyceride) of a fatty acid and glycerin and contains an unsaturated fatty acid as the fatty acid component.

The unsaturated fatty acid glyceride is a component capable of contributing to an enhancement of long-term preservability of the obtained toner image. The unsaturated fatty acid glyceride is hereunder described in detail. The unsaturated fatty acid component is a component which can be hardened itself upon being oxidized. For that reason, in the case where a toner image is formed and fixed on the recording medium using the liquid developer containing an unsaturated fatty acid glyceride, the unsaturated fatty acid glyceride remaining on the toner imager together with the toner particle is able to be subjected to oxidative polymerization with oxygen, etc. in air, whereby the toner particles or the toner particle and the recording medium can be firmly adhered to each other. Since the unsaturated fatty acid glyceride can be subjected to oxidative polymerization while covering the surface of the toner image, it is possible to form a protective film of the unsaturated fatty acid glyceride hardened on the surface toner image. In the light of the above, the toner image can be made a little in deterioration to be caused due to a physical external force such as abrasion, air, light or the like over a long period of time so that it has excellent long-term preservability.

The unsaturated fatty acid which constitutes the glyceride is not particularly limited, and examples thereof include monohydric unsaturated fatty acids such as crotonic acid, myristoleic acid, palmitoleic acid, oleic acid, elaidic acid, vaccenic acid, gadoleic acid, erucic acid and nevonic acid; polyhydric unsaturated fatty acids such as linolic acid, α-linoleic acid, γ-linoleic acid, eleostearic acid, stearidonic acid, arachidonic acid, clupanodonic acid, docosahexaenoic acid (DHA) and eicosapentaenoic acid (EPA); and derivatives thereof. One kind or a combination of two or more kinds selected among these compounds can be used.

In the case where the insulating liquid contains a vegetable oil, the content of the vegetable oil in the insulating liquid is preferably from 20 to 90% by weight, more preferably from 30 to 80% by weight, and further preferably from 40 to 70% by weight. When the content of the vegetable oil in the insulating liquid falls within the foregoing range, the unsaturated fatty acid glyceride remaining on the formed image is appropriate, and the obtained toner image is especially excellent in long-term preservability in view of the matter that a protective film is especially favorably formed on the surface thereof as described previously.

The unsaturated fatty acid glyceride may contain a saturated fatty acid component. When the unsaturated fatty acid glyceride contains a saturated fatty acid component, it is possible to keep chemical stability of the liquid developer or electric insulating properties of the insulating liquid higher.

Examples of a saturated fatty acid which constitutes such a saturated fatty acid component include butyric acid (C4), caproic acid (C6), caprylic acid (C8), capric acid (C10), lauric acid (C12), myristic acid (C14), palmitic acid (C16), stearic acid (C18), arachidic acid (C20), behenic acid (C22) and lignoceric acid (C24). One kind or a combination of two or more kinds selected among these compounds can be used. Of these saturated fatty acids, those having from 6 to 22 carbon atoms in the molecule thereof are preferable, those having from 8 to 20 carbon atoms in the molecule thereof are more preferable, and those having from 10 to 18 carbon atoms in the molecule thereof are further preferable. When the saturated fatty acid component constituted of such a saturated fatty acid is contained, the foregoing effects are more noticeably exhibited.

In the case where the insulating liquid contains a naturally occurring component such as the foregoing fatty acid monoester and unsaturated fatty acid glyceride, the liquid developer (insulating liquid) may contain an antioxidant having a function to prevent or inhibit the oxidation of the naturally occurring component. According to this, it is possible to prevent the reluctant oxidation of the naturally occurring component in the liquid developer. As a result, it is possible to prevent deterioration with time of the liquid developer (insulating liquid) or the like and to bring especially excellent dispersibility of the toner particle, fix level to the recording medium, charge characteristic and the like over a long period of time. That is, it is possible to bring especially excellent environmental stability of the liquid developer.

The insulating liquid may contain other components than the foregoing components.

For example, the liquid developer (insulating liquid) may contain a dispersant capable of enhancing dispersibility of the toner particle.

Examples of such a dispersant include high-molecular dispersants such as polyvinyl alcohol, carboxymethyl cellulose, polyethylene glycol, AJISPAR PB821 (a trade name of Ajinomoto Co., Inc.), polycarboxylic acids and salts thereof, polyacrylic acid metal salts (for example, sodium salts), polymethacrylic acid metal salts (for example, sodium salts), polymaleic acid metal salts (for example, sodium salts), acrylic acid-maleic acid copolymer metal salts (for example, sodium salts), polystyrenesulfonic acid metal salts (for example, sodium salts) and polyamine fatty acid polycondensates; clay minerals; silica; tricalcium phosphate; tristearic acid metal salts (for example, aluminum salts); distearic acid metal salts (for example, aluminum salts and barium salts); stearic acid metal salts (for example, calcium salts, lead salts and zinc salts); linoleic acid metal salts (for example, cobalt salts, manganese salts, lead salts and zinc salts); octanoic acid metal salts (for example, aluminum salts, calcium salts and cobalt salts); oleic acid metal salts (for example, calcium salt and cobalt salts); palmitic acid metal salts (for example, zinc salts); dodecylbenzenesulfonic acid metal salts (for example, sodium salts); naphthenic acid metal salts (for example, calcium salts, cobalt salts, manganese salts, lead salts and zinc salts); and resin acid metal salts (for example, calcium salts, cobalt salts, manganese salts, lead salts and zinc salts).

Among the foregoing dispersants, in the case where a polyamine fatty acid polycondensate is used, the polyamine fatty acid polycondensate can be deposited on the surface of the toner particle, whereby reluctant coagulation of the toner particles each other can be prevented from occurring.

In the case where a polyamine fatty acid polycondensate is used, the content of the polyamine fatty acid polycondensate in the liquid developer is preferably from 0.5 to 7.5 parts by weight, and more preferably from 1 to 5 parts by weight based on 100 parts by weight of the toner particle. According to this, it is possible to make the effect by the use of the polyamine fatty acid polycondensate more remarkable.

Though the viscosity of the insulating liquid is not particularly limited, it is preferably from 5 to 1,000 mPa·s, more preferably from 50 to 800 mPa·s, and further preferably from 100 to 500 mPa·s. When the viscosity of the insulating liquid is a value falling within the foregoing range, in the case where the liquid developer is ladled out into a coating roller from a developer container, an appropriate amount of the insulating liquid is deposited on the toner particle, whereby it is possible to make developability and transfer properties of the toner image especially excellent. Furthermore, not only the dispersibility of the toner particle can be more enhanced, but in an image forming apparatus as described later, the liquid developer can be more uniformly fed into the coating roller, and liquid sag of the liquid developer from the coating roller or the like can be more effectively prevented from occurring. In addition, coagulation and sedimentation of the toner particle can be prevented from occurring, and dispersibility of the toner particle in the insulating liquid can be more enhanced. In contrast, when the viscosity of the insulating liquid is less than the foregoing lower limit value, there is a possibility that problems such as liquid sag of the liquid developer from the coating roller or the like are caused in an image forming apparatus as described later. On the other hand, when the viscosity of the insulating liquid exceeds the foregoing upper limit value, there may be the case where in an image forming apparatus as described later, the liquid developer cannot be more uniformly fed into the coating roller. However, the viscosity as referred to in this specification refers to a value measured at 25° C.

An electric resistivity of the foregoing insulating liquid at room temperature (20° C.) is preferably 1×10⁹ Ωcm or more, more preferably 1×10¹¹ Ωcm or more, and further preferably 1×10¹³ Ωcm or more

A dielectric constant of the insulating liquid is preferably not more than 3.5.

It is preferable that a solid obtained by removing the insulating liquid from the liquid developer of the invention has a Tg measured by DSC of from 15 to 35° C. According to this, it is possible to easily form an image having especially excellent low-temperature fixability and excellent gloss.

### Manufacturing Method of Liquid Developer:

A preferred embodiment of the manufacturing method of the liquid developer of the invention is hereunder described.

The manufacturing method of the liquid developer according to this embodiment includes a dispersion preparation step of preparing a dispersion of at least a resin material and a coloring agent dispersed in an aqueous dispersion medium; a uniting step of uniting plural dispersoids to obtain a united particle; a desolvation step of removing an organic solvent to be contained in the united particle to obtain resin fine particle (toner particle) containing a resin material and a hydrolysis inhibitor; and a dispersion step of dispersing the toner particle in a fatty acid monoester-containing insulating liquid.

Each of the steps constituting the manufacturing method of the liquid developer is hereunder described in detail.

### Dispersion Preparation Step (Aqueous Dispersion Preparation Step):

First of all, a dispersion (aqueous dispersion) is prepared.

The aqueous dispersion may be prepared by any method. For example, constitutional materials (toner materials) of a toner particle such as a resin material and a coloring agent are dissolved or dispersed in an organic solvent to obtain a resin liquid (resin liquid preparation treatment); and an aqueous dispersion medium constituted of an aqueous liquid is added to the resin liquid to form a dispersoid (liquid dispersoid) containing the toner material in an aqueous liquid, thereby obtaining a dispersoid-dispersed dispersion (aqueous dispersion) (dispersoid forming treatment).

### Resin Liquid Preparation Treatment:

First of all, a resin liquid having a resin material and a coloring agent dissolved or dispersed in an organic solvent is prepared.

The prepared resin liquid contains the foregoing constitutional materials of the toner particle and an organic solvent as described below.

As the organic solvent, any material capable of dissolving at least a part of the resin material therein is useful. It is preferable to use one having a boiling point lower than that of an aqueous liquid as described later. According to this, the organic solvent can be easily removed.

It is preferable that the organic solvent has low compatibility with an aqueous dispersion medium (aqueous liquid) as described later (for example, one having a solubility against 100 g of the aqueous dispersion medium at 25° C. of not more than 30 g). According to this, it is possible to finely disperse the toner material in a stable state in an aqueous emulsion.

A composition of the organic solvent can be properly chosen depending upon the composition of the foregoing resin material and coloring agent, the composition of the aqueous dispersion medium and the like.

Such an organic solvent is not particularly limited, and examples thereof include ketone based solvents such as MEK; and aromatic hydrocarbon based solvents such as toluene.

The resin liquid can be, for example, obtained by mixing a resin material, a hydrolysis inhibitor, an organic solvent and the like by a stirrer, etc. Examples of the stirrer which can be used for the preparation of the resin liquid include high-speed stirrers such as DESPA (manufactured by Asada Iron Works Co., Ltd.) and T.K. ROBOMIX/T.K. HOMODISPER 2.5 MODEL (manufactured by Primix Corporation).

The material temperature at the time of stirring is preferably from 20 to 60° C., and more preferably from 30 to 50° C.

Though the content of a solid in the resin liquid is not particularly limited, it is preferably from 40 to 75% by weight, more preferably from 50 to 73% by weight, and further preferably from 50 to 70% by weight. When the content of the solid is a value falling within the foregoing range, it is possible to make a dispersoid constituting the dispersion (emulsion suspension) as described later have a higher sphericity (shape closed to a true sphere) and to make the shape of the ultimately obtained toner particle favorable more surely.

In the preparation of the resin liquid, all the constitutional components of the resin liquid to be prepared may be mixed simultaneously, or a part of the constitutional components of the resin liquid to be prepared may be previously mixed to obtain a mixture (master), followed by mixing the mixture (master) with other components.

For example, the resin liquid may be prepared by kneading a resin material and a coloring agent to obtain a coloring agent master as a kneaded material and then mixing the coloring agent master with a resin material as an additional resin and an organic solvent having a hydrolysis inhibitor dissolved therein. According to this, it is possible to involve the hydrolysis inhibitor more surely in the toner particle. Also, a resin liquid in which the respective components are uniformly mixed with each other can be more surely obtained.

### Dispersoid Forming Treatment:

An aqueous dispersion (dispersion) is subsequently prepared.

An aqueous dispersion medium constituted of an aqueous liquid is added in the resin liquid to form a toner material-containing dispersoid (liquid dispersoid) in the aqueous liquid, thereby obtaining a dispersion having the dispersoid dispersed therein (aqueous dispersion).

The aqueous dispersion medium is one constituted of an aqueous liquid.

As the aqueous liquid, one constituted mainly of water can be used.

The aqueous liquid may be one containing a solvent having excellent affinity with water (for example, a solvent having a solubility against 100 parts by weight of water at 25° C. of 50 parts by weight or more).

An emulsion dispersant may be added in the aqueous dispersion medium as the need arises. By adding the emulsion dispersant, it is possible to more easily prepare an aqueous emulsion.

The emulsion dispersant is not particularly limited, and for example, a known emulsion dispersant can be used.

In the preparation of the aqueous dispersion, for example, a neutralizing agent may be used. According to this, for example, it is possible to neutralize a functional group (for example, a carboxyl group) which the resin material has and to make the shape of the dispersoid in the aqueous dispersion to be prepared, the uniformity in size and the dispersibility of the dispersoid especially excellent. For that reason, the obtained toner particle has especially narrow particle size distribution.

The neutralizing agent may be, for example, one to be added in the resin liquid or one to be added in the aqueous liquid.

In the preparation of the aqueous dispersion, the neutralizing agent may be one to be added dividedly several times.

As the neutralizing agent, a basic compound can be used. More specifically, examples of the neutralizing agent include inorganic bases such as sodium hydroxide, potassium hydroxide and ammonia; and organic bases such as diethylamine, triethylamine and isopropylamine. One kind or a combination of two or more kinds selected among these compounds can be used. The neutralizing agent may also be an aqueous solution containing the foregoing compound.

The use amount of the basic compound is preferably an amount corresponding to from 1 to 3 times the necessary amount for neutralizing all carboxyl groups which the resin material has (from 1 to 3 equivalents), and more preferably an amount corresponding to from 1 to 2 times the necessary amount for neutralizing all carboxyl groups which the resin material has (from 1 to 2 equivalents). According to this, it is possible to effectively prevent the formation of a heteromorphous dispersoid from occurring and to make the particle size distribution of the particle to be obtained in a uniting step as described later in detail sharper.

Though the addition of the aqueous liquid to the resin liquid may be carried out by any method, it is preferable to add an aqueous liquid containing water to the resin liquid while stirring the resin liquid. That is, it is preferable that by gradually adding (dropping) the aqueous liquid in the resin liquid while applying a shear to the resin liquid by a stirrer, etc., a W/O type emulsion is subjected to phase inversion into an O/W type emulsion, thereby ultimately obtaining an aqueous dispersion having a resin-derived dispersoid dispersed in the aqueous liquid.

Examples of the stirrer which can be used for the preparation of the aqueous dispersion include high-speed stirrers or high-speed dispersers such as DESPA (manufactured by Asada Iron Works Co., Ltd.) and T.K. ROBOMIX/T.K. HOMODISPER 2.5 MODEL (manufactured by Primix Corporation), SLASHER (manufactured by Mitsui Mining Co., Ltd.) and CAVITRON (manufactured by Eurotec, Inc.).

At the time of adding the aqueous liquid to the resin liquid, it is desirable to carry out the stirring such that a blade tip speed is preferably from 10 to 20 m/sec, and more preferably from 12 to 18 m/sec. When the blade tip speed is a value falling within the foregoing range, not only it is possible to efficiently obtain the aqueous dispersion, but it is possible to make scattering in shape and size of the dispersoid in the aqueous dispersion especially small. Also, it is possible to make the uniform dispersibility of the dispersoid especially excellent while preventing the generation of an excessively fine dispersoid or a coarse particle.

Though the content of a solid in the aqueous dispersion is not particularly limited, it is preferably from 5 to 55% by weight, and more preferably from 10 to 50% by weight. According to this, it is possible to make the productivity of the toner particle especially excellent while more surely preventing reluctant coagulation among the dispersoids in the aqueous dispersion from occurring.

The material temperature in this treatment is preferably from 20 to 60° C., and more preferably from 20 to 50° C.

### Uniting Step:

Next, plural dispersoids are united to obtain a united particle (uniting step). Uniting of the dispersoids usually proceeds due to the matter that the dispersoids containing an organic solvent come into collision each other and are integrated.

The uniting of plural dispersoids is carried out by adding an electrolyte in the dispersion while stirring the dispersion. According to this, it is possible to obtain a united particle easily and surely. Also, by adjusting the addition amount of the electrolyte, it is possible to control the particle size and particle size distribution of the united particle easily and surely.

The electrolyte is not particularly limited, and one kind of a combination of two or more kinds of known organic or inorganic water-soluble salts and the like can be used.

The electrolyte is preferably a salt of a monovalent cation. According to this, it is possible to make the obtained united particle have narrow particle size distribution. By using a salt of a monovalent cation, it is also possible to surely prevent the generation of a coarse particle in this step from occurring.

Above all, the electrolyte is preferably a sulfate (for example, sodium sulfate and ammonium sulfate) or a carbonate, and especially preferably a sulfate. According to this, it is possible to especially easily control the particle size of the united particle.

The amount of the electrolyte to be added in this step is preferably from 0.5 to 3 parts by weight, and more preferably from 1 to 2 parts by weight based on 100 parts by weight of the solid to be contained in the dispersion to which the electrolyte is added. According to this, it is possible to control the particle size of the united particle especially easily and surely and to surely prevent the generation of a coarse particle from occurring.

It is preferable that the electrolyte is added in a state of an aqueous solution. According to this, it is possible to quickly diffuse the electrolyte in the whole of the dispersion and to control the addition amount of the electrolyte easily and surely. As a result, it is possible to obtain a united particle having especially narrow particle size distribution in a desired particle size.

In the case where the electrolyte is added in a state of an aqueous solution, the concentration of the electrolyte in the aqueous solution is preferably from 2 to 10% by weight, and more preferably from 2.5 to 6% by weight. According to this, it is possible to especially quickly diffuse the electrolyte in the whole of the dispersion and to control the addition amount of the electrolyte easily and surely. By adding such an aqueous solution, the content of water in the dispersion at the time of completion of the addition of the electrolyte becomes suitable. For that reason, it is possible to make the growth speed of the united particle after the addition of the electrolyte properly slow to an extent that the productivity does not drop. As a result, it is possible to more surely control the particle size. It is also possible to surely prevent reluctant uniting of the united particle from occurring.

In the case where the electrolyte is added as its aqueous solution, the addition rate of the electrolyte aqueous solution is preferably from 0.5 to 10 parts by weight/min, and more preferably from 1.5 to 5 parts by weight/min based on 100 parts by weight of the solid to be contained in the dispersion to which the electrolyte aqueous solution is added. According to this, it is possible to prevent the generation of unevenness in the concentration of the electrolyte in the dispersion and to surely prevent the generation of a coarse particle from occurring. Also, the particle size distribution of the united particle becomes especially narrow. Furthermore, by adding the electrolyte at such a rate, not only it is possible to especially easily control the uniting rate and to especially easily control the average particle size of the united particle, but it is possible to make the productivity of the toner especially excellent.

The addition of the electrolyte may be carried out dividedly several times. According to this, not only it is possible to obtain a united particle having a desired size, but it is possible to surely make the roundness of the obtained united particle sufficiently large.

This step is carried out in a state that the dispersion is stirred. According to this, it is possible to obtain a united particle which is especially small in scattering in the shape and size among the particles.

For stirring the dispersion, stirring blades, for example, an anchor blade, a turbine blade, a pfaudler blade, a full zone blade, maxblend blade and a semicircular blade can be used. Of these, a maxblend blade and a full zone blade are preferable. According to this, it is possible to disperse or dissolve the added electrolyte quickly and uniformly, thereby surely preventing the generation of unevenness in the concentration of the electrolyte from occurring. It is also possible to more surely prevent collapse of the once formed united particle from occurring while efficiently uniting the dispersoid. As a result, it is possible to efficiently obtain a united particle having small scattering in the shape and particle size among the particles.

A blade tip speed of the stirring blade is preferably from 0.1 to 10 m/sec, more preferably from 0.2 to 8 m/sec, and further preferably from 0.2 to 6 m/sec. When the blade tip speed is a value falling within the foregoing range, it is possible to uniformly disperse or dissolve the added electrolyte, thereby surely preventing the generation of unevenness in the concentration of the electrolyte from occurring. It is also possible to more surely prevent collapse of the once formed united particle from occurring while more efficiently uniting the dispersoid.

The average particle size of the formed united particle is preferably from 0.1 to 7 μm, and more preferably from 0.5 to 5 μm. According to this, it is possible to make the particle size of the ultimately obtained toner particle favorable.

### Desolvation Step:

Thereafter, the organic solvent to be contained in the dispersion is removed. According to this, a resin fine particle (united particle) having been dispersed in the dispersion is obtained.

The removal of the organic solvent may be carried out by any method, and for example, it can be carried out by reducing the pressure. According to this, it is possible to efficiently remove the organic solvent while sufficiently preventing denaturation of the constitutional materials such as the resin material from occurring.

The treatment temperature in this step is preferably a temperature lower than a glass transition point (Tg) of the resin material constituting the united particle.

This step may be carried out in a state that an antifoaming agent is added. According to this, it is possible to efficiently remove the organic solvent.

As the antifoaming agent, for example, in addition to mineral oil based antifoaming agents, polyether based antifoaming agents and silicone based antifoaming agents, lower alcohols, higher alcohols, oils and fats, fatty acids, fatty acid esters, phosphoric esters, etc. can be used.

Though the use amount of the antifoaming agent is not particularly limited, it is preferably from 20 to 300 ppm, and more preferably from 30 to 100 ppm in terms of a weight ratio relative to the solid to be contained in the dispersion.

In this step, at least a part of the aqueous liquid may be removed together with the organic solvent.

In this step, the whole of the organic solvent (the whole amount of the organic solvent to be contained in the dispersion) may be not always removed. Even in such case, the residual organic solvent can be thoroughly removed in other steps as described later.

### Washing Step:

Next, the thus formed united particle is washed (washing step).

By achieving this step, even in the case where the organic agent and the like are contained as impurities, these can be efficiently removed. As a result, it is possible to especially minimize the amount of total volatile organic compounds (TVOC) in the ultimately obtained resin fine particle.

This step can be, for example, achieved by separating the resin fine particle through solid-liquid separation (separation from the aqueous liquid) and then further performing redispersion of the solid (resin fine particle) in water and solid-liquid separation (separation of the resin fine particle from the aqueous liquid). The redispersion of the solid in water and solid-liquid separation may be repeatedly performed several times.

### Drying Step:

Thereafter, the united particle can be obtained through a drying treatment (drying step).

The drying step can be, for example, carried out using a vacuum dryer (for example, RIBOCONE (manufactured by Okawara Corporation) and NAUTA (manufactured by Hosokawa Micron Corporation), a fluid bed dryer (manufactured by Okawara Corporation), etc.

An oxide powder of a nano size such as silica may be mixed as a drying auxiliary, followed by drying. According to this, drying can be achieved for a shorter time, thereby preventing coagulation from occurring. Mixing of an excess of water in the liquid developer results in reduction of electric resistivity, unstableness of charge and deterioration of a carrier, and therefore, it is necessary to achieve thorough drying.

### Dispersion Step:

The thus obtained united particle is dispersed into a fatty acid monoester (dispersion step). In this step, the united particle coagulated at the time of drying is picked off and also adjusted so as to have a desired size as the liquid developer, thereby shaping the toner particle in a disc form.

In this step, the dispersion is carried out using a hard medium. That is, the coagulated united particle is dispersed in the presence of a fatty acid monoester by passing through, for example, hard iron balls, alumina balls or zirconia spheres. At that time, the size of the medium is adjusted depending upon the desired toner size. Then, the united particle is crushed between the hard spheres or between the container and the sphere so that it becomes flattened. This flattened particle is plasticized with the fatty acid monoester existing in the surroundings and swollen, whereby the toner particle in a disc form is shaped. According to this, there is obtained a toner particle dispersion in which the toner particle in a disc form is dispersed in the fatty acid monoester.

During the dispersion, the fatty acid monomer penetrates into the whole of the toner particle, whereby the plasticizer effect becomes more remarkable. As a result, the toner particle is easy to get into gaps of a paper fiber (recording medium), and therefore, not only it is possible to make the fix level of the toner particle especially excellent, but it is possible to reduce gloss unevenness of the formed image and to make it excellent.

When the united particle is dispersed in the fatty acid monoester, by simultaneously adding a dispersant, it is possible to unevenly distribute (adsorb) the dispersant in the vicinity of the surface of the toner particle in the ultimately obtained liquid developer, thereby firmly adsorbing it.

As to the dispersant for liquid developer, a dispersant utilizing steric hindrance is more effective. In that case, the foregoing high-molecular dispersant is used. It is desirable that the dispersant is melted in the insulating liquid and adsorbed onto (made affinitive with) the surface of the toner particle. When the dispersant is dispersed in the fatty acid monoester, the dispersant is physically pressed against the surface of the plasticized toner particle, whereby adsorption firmly proceeds. When the dispersant is unevenly distributed in the vicinity of the surface of the toner particle in this way, it is possible to make the storage stability of the liquid developer excellent. Also, it is possible to prevent the generation of a coarse toner particle due to coagulation or the like from occurring.

In this embodiment, since the particle size distribution of the obtained toner particle is sharp, not only a fine particle does not originally exist, but a coarse particle does not exist. Therefore, according to this embodiment, pulverization is not required, and it is possible to effectively prevent the generation of a fine particle (a particle having a particle size extremely smaller than that of the desired particle size) as compared with the existing pulverization method or wet pulverization method. As a result, it is possible to form a developer composed of a toner particle having a desired narrow particle size distribution within a short period of time, resulting in enabling one to effectively prevent a lowering of charge characteristic of the liquid developer to be caused due to a fine particle from occurring.

Since the fatty acid monoester has a relatively low viscosity, it is easy to penetrate into the united particle in the drying step, whereby the associated particle can be favorably dispersed.

As to a device to be used for dispersion, any device is employable so far as the medium can be relatively stirred in the container. Examples of the device which can be used include a ball mill, a planetary ball mill, a grain mill, a bead mill and a paint shaker.

Though the time required for dispersion varies depending upon an instrument to be used for dispersion, for example, in the case where the dispersion is achieved in a ball mill using a zirconia ball having a diameter of from about 1 to 10 mm, the dispersion time is preferably from about 10 to 300 hours, and more preferably from about 20 to 150 hours. According to this, not only the dispersion can be efficiently achieved, but a toner particle having in a disc form can be efficiently shaped. Also, it is possible to prevent the generation of a fine particle from occurring and to manufacture a liquid developer having a uniform toner particle size.

Thereafter, by adding the remaining insulating liquid component in the obtained toner particle dispersion, the liquid developer of the invention is obtained.

In the foregoing description, while the case of using a fatty acid monoester for dispersion has been described, it should not be construed that the invention is not limited thereto. For example, other insulating liquid component may be added as a liquid to be used for dispersion in the fatty acid monoester.

### Image Forming Apparatus:

Next, a preferred embodiment of the image forming apparatus of the invention is described. The image forming apparatus of the invention is an apparatus for forming a color image on a recording medium using the foregoing liquid developer of the invention.

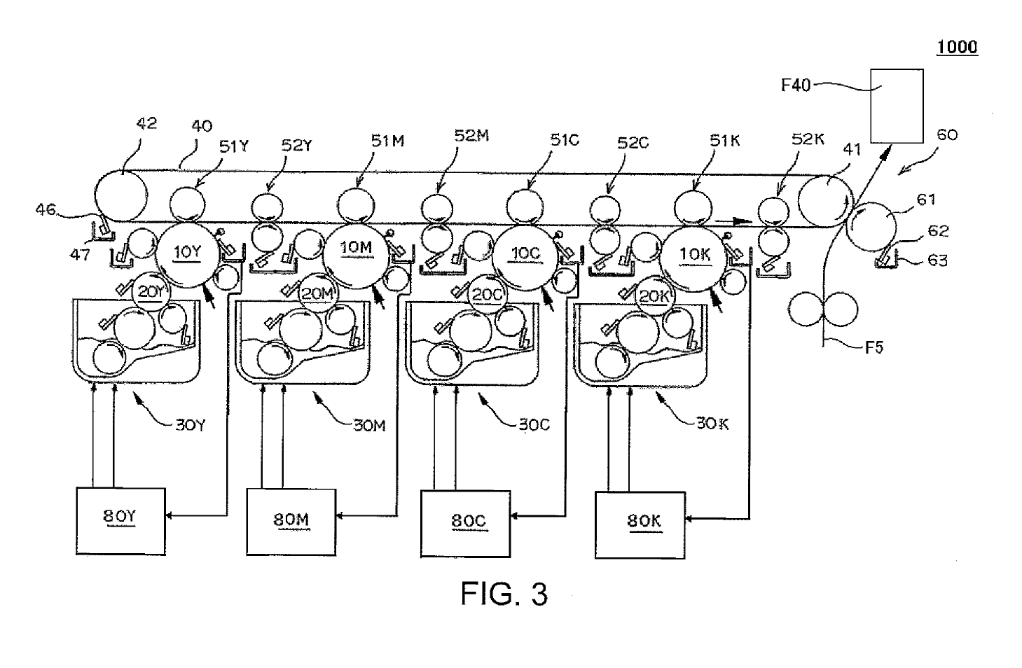

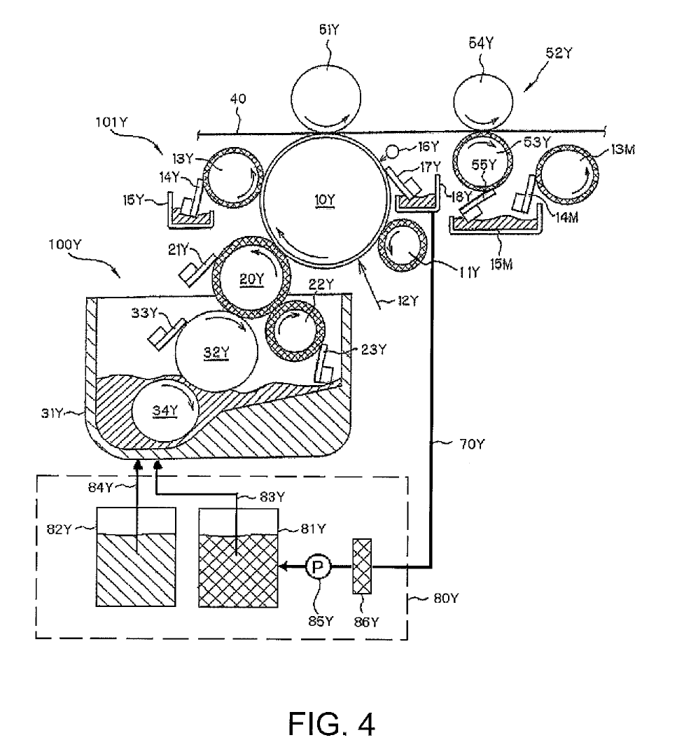

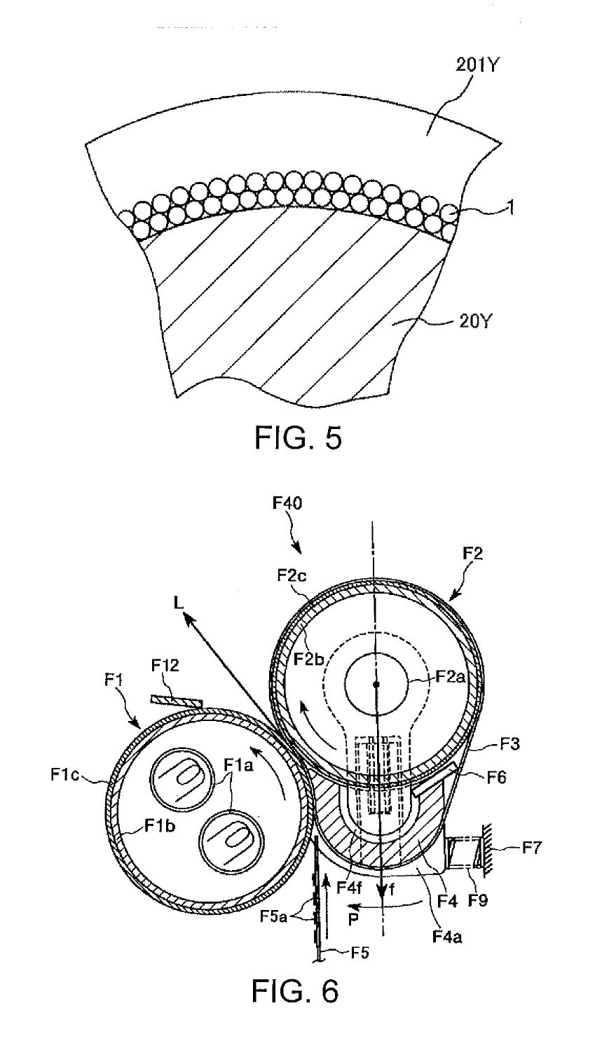

FIG. 3 is a schematic view illustrating an embodiment of an image forming apparatus to which the liquid developer of the invention is applied; FIG. 4 is an enlarged view enlarging a part of the image forming apparatus as illustrated in FIG. 3; FIG. 5 is a schematic view illustrating the state of a toner particle in a liquid developer layer on a developing roller; and FIG. 6 is a cross-sectional view illustrating an embodiment of a fixing device to be applied to the image forming apparatus as illustrated in FIG. 3.

As illustrated in FIGS. 3 and 4, an image forming apparatus 1000 has four development parts 30Y, 30M, 30C and 30K; an intermediate transfer part 40; a secondary transfer unit (secondary transfer part) 60; a fixing part (fixing device) F40; and four liquid developer replenishing parts 80Y, 80M, 80C and 80K.

The development parts 30Y, 30M and 30C have a function to develop a latent image with a yellow based liquid developer (Y), a magenta based liquid developer (M) and a cyan based liquid developer (C), respectively, thereby forming a monochromic image of a color corresponding to the respective colors. The development part 30K has a function to develop a latent image with a black based liquid developer (K), thereby forming a monochromic image of black.

Since the configurations of the development parts 30Y, 30M, 30C and 30K are the same as each other, the development part 30Y is hereunder described.

As illustrated in FIG. 4, the development part 30Y has a photoconductor 10Y as one example of an image carrier; a charge roller 11Y along the rotation direction of the photoconductor 10Y; an exposure unit 12Y; a development unit 100Y; a photoconductor squeeze device 101Y; a primary backup roller 51Y; a discharge unit 16Y; a photoconductor cleaning blade 17Y; and a developer recovery part 18Y.

The photoconductor 10Y has a cylindrical substrate and a photosensitive layer formed on the outer peripheral surface thereof and is rotatable centering on a central axis thereof. In this embodiment, the photoconductor 10Y rotates clockwise as shown by an arrow in FIG. 3.

In the photoconductor 10Y, a liquid developer is fed from the development unit 100Y as described later, and a layer of the liquid developer is formed on the surface thereof.

The charge roller 11Y is a device for charging the photoconductor 10Y; and the exposure unit 12Y is a device for forming a latent image on the photoconductor 10Y to be charged upon irradiation with laser. This exposure unit 12Y has a semiconductor laser, a polygon mirror, an F-θ lens and the like and irradiates a modulated laser on the charged photoconductor 10Y on the basis of an image signal inputted from a non-illustrated host computer such as a personal computer and a word processor.

The development unit 100Y is a device for developing the latent image formed on the photoconductor 10Y with the liquid developer of the invention. Details of the development unit 100Y are described later.

The photoconductor squeeze device 101Y is disposed opposing to the photoconductor 10Y on a downstream side in the rotation direction relative to the development unit 100Y and configured of a photoconductor squeeze roller 13Y, a cleaning blade 14Y which comes into press slide contact with the photoconductor squeeze roller 13Y to remove the liquid developer deposited on the surface thereof and a developer recovery part 15Y for recovering the removed liquid developer. This photoconductor squeeze device 101Y has a function to recover an excessive carrier (insulating liquid) from the developer developed on the photoconductor 10Y and an originally unnecessary fogged toner to increase a ratio of the toner particle in a visible image.

The primary backup roller 51Y is a device for transferring a monochromic image formed on the photoconductor 10Y onto the intermediate transfer part 40 as described later.

The discharge unit 16Y is a device for, after transferring an intermediate transferred image onto the intermediate transfer part 40 by the primary transfer backup roller 51Y, removing a residual charge on the photoconductor 10Y.

The photoconductor cleaning blade 17Y is a rubber-made member to be brought into contact with the surface of the photoconductor 10Y and has a function for, after transferring an image onto the intermediate transfer part 40 by the primary transfer backup roller 51Y, scrapping off and removing the remaining liquid developer on the photoconductor 10Y.

The developer recovery part 18Y has a function to recover the liquid developer removed by the photoconductor cleaning blade 17Y.

The intermediate transfer part 40 is an endless elastic belt member and is wound around and stretched between a belt drive roller 41 and a tension roller 42 and rotated and driven by the drive roller 41 while coming into contact with photoconductors 10Y, 10M, 10C and 10K by primary transfer backup rollers 51Y, 51M, 51C and 51K, respectively.

In this intermediate transfer part 40, monochromic images corresponding to the respective colors formed in the development parts 30Y, 30M, 30C and 30K are successively transferred by the primary transfer backup rollers 51Y, 51M, 51C and 51K, whereby the monochromic images corresponding to the respective colors are superimposed. According to this, a full-color developer image (intermediate transferred image) is formed in the intermediate transfer part 40.

In the intermediate transfer part 40, the thus formed plural monochromic images on the photoconductors 10Y, 10M, 10C and 10K are successively secondarily transferred, superimposed and carried, thereby secondarily transferring collectively onto a recoding medium F5 such as paper, a film and a cloth collectively. For that reason, in transferring the toner image onto the recording medium F5 in the secondary transfer step, even in a sheet material in which the surface of the recording medium F5 is not smooth by a fibrous material, the elastic belt member is employed by a measure for enhancing the secondary transfer characteristic following this non-smooth sheet material surface.

A cleaning device composed of an intermediate transfer part cleaning blade 46 and a developer recovery part 47 is disposed on the side of the tension roller 42 for stretching the intermediate transfer part 40 together with the belt drive roller 41.

The intermediate transfer part cleaning blade 46 has a function for, after transferring an image onto the recording medium 5F by a secondary transfer roller 61, scraping off and removing the liquid developer deposited on the intermediate transfer part 40.

The developer recovery part 47 has a function to recover the liquid developer removed by the intermediate transfer part cleaning blade 46.

An intermediate transfer part squeeze device 52Y is disposed on the downstream side in the movement direction of the intermediate transfer part 40 relative to the primary transfer backup roller 51Y.

In the case where the liquid developer transferred onto the intermediate transfer part 40 does not become in a desired dispersed state, this intermediate transfer part squeeze device 52Y is provided as a measure for removing the excessive insulating liquid from the transferred liquid developer.

The intermediate transfer part squeeze device 52Y is configured of an intermediate transfer part squeeze roller 53Y; an intermediate transfer part squeeze backup roller 54Y to be disposed opposing to the intermediate transfer part squeeze roller 53Y across the intermediate transfer part 40; an intermediate transfer part squeeze cleaning blade 55Y which comes into press slide contact with the intermediate transfer part squeeze roller 53Y to cleanup the surface; and a developer recovery part 15M.

The intermediate transfer part squeeze device 52Y has a function to recover an excessive carrier from the developer primarily transferred onto the intermediate transfer part 40, thereby increasing a ratio of the toner particle in a visible image and recovering an originally unnecessary fogged toner. In the developer recovery part 15M, a recovery mechanism of the carrier to be recovered by a cleaning blade 14M of a magenta photoconductor squeeze roller 13M disposed on the downstream side in the movement direction of the intermediate transfer part 40 is also made to serve as the intermediate transfer part squeeze cleaning blade 55Y of the intermediate transfer part squeeze roller 53Y. According to this, by making developer recovery parts 15M, 15C and 15K of image carrier squeeze device of the second color, et seq. (the developer recovery parts 15C and 15K are not illustrated) serve also as developer recovery parts of the intermediate transfer part squeeze device 52 (Y, M and C) to be disposed on the downstream side in the movement direction of the intermediate transfer part 40 relative to the primary transfer backup rollers 51 (Y, M and C) of the preceding color, it is possible to regulate gaps thereof constant and to simplify the structure, thereby devising to achieve downsizing.

In the secondary transfer unit 60, the secondary transfer roller 61 is disposed opposing to the belt drive roller 41 across the intermediate transfer part 40, and a cleaning device composed of a cleaning blade 62 of the secondary transfer roller 61 and a developer recovery part 63 is disposed.

In the secondary transfer unit 60, the recording medium F5 is conveyed and fed in conformity with the timing of arrival of an intermediate transferred image formed by superimposing colors on the intermediate transfer part 40 at a transfer position of the secondary transfer unit 60, thereby secondarily transferring the intermediate transferred image onto the recording medium F5.

A toner image (transferred image) F5a transferred onto the recording medium F5 by the secondary transfer unit 60 is sent to a fixing part F40 as described later and fixed.

The cleaning blade 62 has a function for, after transferring an image onto the recording medium F5 by the secondary transfer roller 61, scraping off and removing the liquid developer deposited on the secondary transfer roller 61.

The developer recovery part 63 has a function to recovery the liquid developer removed by the cleaning blade 62.

Next, development units 100Y, 100M, 100C and 100K are hereunder described in detail. In the following description, the development unit 100Y is representatively described.

As illustrated in FIG. 4, the development unit 100Y has a liquid developer storage part 31Y, a coating roller 32Y, a regulating blade 33Y, a developer stirring roller 34Y, a development roller 20Y, a development roller cleaning blade 21Y and a developer compression roller (compression unit) 22Y.

The liquid developer storage part 31Y is one provided with a function to store the liquid developer for developing a latent image formed on the photoconductor 10Y.

The coating roller 32Y is one provided with a function to feed the liquid developer into the development roller 20Y.

This coating roller 32Y is a so-called nickel-plated anilox roller in which grooves are formed uniformly and helically on the surface of a roller made of a metal such as iron, and its diameter is about 25 mm. In this embodiment, plural grooves are formed obliquely against the rotation direction of the coating roller 32Y by means of so-called cutting work or rolling work or the like. When this coating roller 32 comes into contact with the liquid developer while rotating clockwise, the liquid developer in the liquid developer storage part 31Y is carried by the grooves, and the carried liquid developer is conveyed into the development roller 20Y.

The regulating blade 33Y comes into contact with the surface of the coating roller 32Y, thereby regulating the amount of the liquid developer on the coating roller 32Y. That is, the regulating blade 33Y plays a role for scraping off the excessive liquid developer on the coating roller 32Y and metering the liquid developer on the coating roller 32Y to be fed into the development roller 20Y. This regulating blade 33Y is composed of a polyurethane rubber as an elastic body and is supported by a regulating blade support member made of a metal such as iron. The regulating blade 33Y is provided on the side where the coating roller 32Y rotates and advances from the liquid developer as seen from the vertical plane A (that is, the left side in FIG. 4 as seen from the vertical plane A). A rubber hardness of the regulating blade 33Y is about 77 degrees according to JIS-A, and the hardness (about 77 degrees) of the contact part of the regulating blade 33Y with the surface of the coating roller 32Y is lower than a hardness (about 85 degrees) of the press contact part of a layer of the elastic part of the development roller 20Y as described later with the surface of the coating roller 32Y. The scraped off excessive liquid developer is recovered in the liquid developer storage part 31Y and reused.

The developer stirring roller 34Y is one provided with a function to stir the liquid developer in a uniformed dispersed state. According to this, even in the case where plural toner particles 1 are coagulated, it is possible to favorably disperse the toner particles 1 each other. In particular, even in the case where the liquid developer which has been once used is reused, it is possible to favorably disperse the toner particles 1.

In the liquid developer storage part 31Y, the toner particles 1 in the liquid developer have a plus charge. The liquid developer is stirred by the developer stirring roller 34Y to become in a uniformly dispersed state; when the coating roller 32Y rotates, the liquid developer is drawn up from the liquid developer storage part 31Y; and the amount of the liquid developer is regulated by the regulating blade 33Y, whereby the liquid developer is fed into the development roller 20Y.

For the purpose of developing a latent image carried on the photoconductor 10Y with the liquid developer, the development roller 20Y carries the liquid developer thereon and conveys it at a development position opposing to the photoconductor 10Y.

The development roller 20Y is one for feeding the liquid developer from the coating roller 32Y, thereby forming a liquid developer layer 201Y on the surface thereof.

This development roller 20Y is one provided with a layer of a conductive elastic body in the outer peripheral part of an inner core made of a metal such as iron and has a diameter of about 20 mm. The layer of the elastic body has a two-layer structure in which a polyurethane rubber having a rubber hardness of about 30 degrees according to JIS-A and having a thickness of about 5 mm is provided as an internal layer thereof, and a polyurethane rubber having a rubber hardness of about 85 degrees according to JIS-A and a thickness of about 30 μm is provided as a surface layer (external layer) thereof. In the development roller 20Y, the surface layer works as a press contact part and comes into press contact with the coating roller 32Y and the photoconductor 10Y, respectively in an elastically deformed state.

The development roller 20Y is rotatable centering on a central axis thereof, and the central axis is disposed downward relative to the rotation central axis of the photoconductor 10Y. The development roller 20Y rotates in a reverse direction (counterclockwise direction in FIG. 4) against the rotation direction (clockwise direction in FIG. 4) of the photoconductor 10Y. In developing the latent image formed on the photoconductor 10Y, an electric field is formed between the development roller 20Y and the photoconductor 10Y.

The developer compression roller 22Y is a device provided with a function to make the toner of the liquid developer carried on the development roller 20Y in a compressed state. In other words, the developer compression roller 22Y is a device provided with a function to unevenly distribute the toner particles 1 in the vicinity of the surface of the development roller 20Y in the liquid developer layer 201Y as illustrated in FIG. 5 by applying an electric field with the same polarity as the toner particles 1 to the liquid developer layer 201Y. By unevenly distributing the toner particles in this way, it is possible to increase the development density (development efficiency). As a result, it is possible to obtain a sharp image with high quality.

This developer compression roller 22Y is provided with a cleaning blade 23Y.

This cleaning blade 23Y has a function to remove the liquid developer deposited on the developer compression roller 22Y. The liquid developer removed by the cleaning blade 23Y is recovered in the liquid developer storage part 31Y and reused.

The development unit 100Y has the development roller cleaning blade 21Y made of a rubber coming into contact with the surface of the development roller 20Y. This development roller cleaning blade 21Y is a device for, after performing the development at the development position, scraping off and removing the remaining liquid developer on the development roller 20Y. The liquid developer removed by the development roller cleaning blade 21Y is recovered in the liquid developer storage part 31Y and reused.

As illustrated in FIGS. 3 and 4, the image forming apparatus 1000 has the liquid developer replenishing parts 80Y, 80M, 80C and 80K for replenishing the liquid developer into the development parts 30Y, 30M, 30C and 30K, respectively. Since the configurations of the liquid developer replenishing parts 80Y, 80M, 80C and 80K are the same as each other, the liquid developer replenishing part 80Y is hereunder described.

The liquid developer replenishing part 80Y has a recovery liquid developer storage part 81Y, a replenishing liquid developer storage part 82Y, conveyance units 83Y and 84Y, a pump 85Y and a filter 86Y.

The recovery liquid developer storage part 81Y stores a recovery liquid developer recovered mainly in the developer recovery part 18Y and replenishes the recovery liquid developer into the liquid developer storage part 31Y of the development part 30Y by the conveyance unit 83Y. In the replenishing liquid developer storage part 82Y, the liquid developer is stored, and the liquid developer is replenished into the liquid developer storage part 31Y by the conveyance unit 84Y. The composition of each of the liquid developer stored in the replenishing liquid developer storage part 82Y and the recovery liquid developer stored in the recovery liquid developer storage part 81Y may be the same as or different from that of the liquid developer stored in the liquid developer storage part 31Y.

The liquid developer recovered in the developer recovery part 18Y is fed into the liquid developer replenishing part 80Y through a conveyance passage 70Y.

The pump 85Y is provided in the conveyance passage 70Y, and the liquid developer recovered in each developer recovery part is conveyed into the recovery liquid developer storage part 81Y by this pump 85Y.

Also, the filter 86Y is provided in the conveyance passage 70Y and is able to remove coarse particles, foreign matters and the like from the liquid developer. Solids removed by the filter 86Y, such as coarse particles and foreign matters, are detected by a non-illustrated detector unit in a filter state. The filter 86Y is exchanged on the basis of detection results. According to this, it is possible to keep the filtering function of the filter 86Y stable.

Next, the fixing part is hereunder described.

The fixing part F40 is one for fixing the unfixed toner image F5a formed in the foregoing development part or transfer part or the like on the recording medium F5.

As illustrated in FIG. 6, the fixing part F40 has a heat fixing roller F1, a pressure roller F2, a heat-resistant belt F3, a belt stretching member F4, a cleaning member F6, a frame F7 and a spring F9.

The heat fixing roller (fixing roller) F1 has a roller substrate F1b constituted of a pipe material, an elastic body F1c for covering its outer periphery and a pillar-like halogen vapor lump F1a as a heating source in the inside of the roller substrate F1b and is rotatable in a counterclockwise direction as shown by an arrow in the drawing.

In the inside of the heat fixing roller F1, two pillar-like halogen vapor lumps F1a and F1a configuring a heating source are built therein, and heating elements of these pillar-like halogen vapor lamps F1a and F1a are disposed at a different position from each other. When the respective pillar-like halogen vapor lamps F1a and F1a are selectively turned on a light, the temperature control is easily achieved under a condition where a fixing nip site at which the heat-resistant belt F3 as described later is wound around the heat fixing roller F1 is different from a site at which the belt stretching member F4 as described later comes into slide contact with the heat fixing roller F1, a different condition between a wide recording medium and a narrow recording medium or the like.

The pressure roller F2 is disposed opposing to the heat fixing roller F1 and configured so as to apply a pressure to the recording medium F5 on which the unfixed toner image F5a has been formed via the heat-resistant belt F3 as described later.

The pressure roller F2 has a roller substrate F2b constituted of a pipe material and an elastic body F2c for covering its outer periphery and is rotatable in a clockwise direction as shown by an arrow in the drawing.

A PFA layer is provided on the surface layer of the elastic body F1c of the heat fixing roller F1. According to this, though the respective elastic bodies F1c and F2c are different in thickness from each other, the both elastic bodies F1c and F2c are elastically deformed in a substantially uniform manner, whereby a so-called horizontal nip is formed. Also, a difference in the conveyance rate of the heat-resistant belt F3 as described later or the recording medium F5 is not caused relative to the peripheral speed of the heat fixing roller F1, and therefore, it is possible to achieve extremely stable image fixing.

The heat-resistant belt F3 is an endless annular belt which is made movable while being stretched between the pressure roller F2 and the outer periphery of the belt stretching member F4 and interposed under pressure between the heat fixing roller F1 and the pressure roller F2.

This heat-resistant belt F3 has a thickness of 0.03 mm or more and is formed of a seamless tube of a two-layer configuration in which the front surface (surface on the side with which the recording medium F5 comes into contact) is formed of PFA, whereas the back surface (surface on the side coming into contact with the pressure roller F2 and the belt stretching member F4) is formed of a polyimide. However, the heat-resistant belt F3 is not limited thereto but can be formed of other material such as a metallic tube, for example, a stainless steel tube and a nickel electrocast tube, or a heat-resistant resin tube, for example, a silicone tube.

The belt stretching member F4 is disposed on the upstream side in the conveyance direction of the recording medium F5 relative to a fixing nip part between the heat fixing roller F1 and the pressure roller F2 and disposed rockably in an arrow P direction centering on a rotation axis F2a of the pressure roller F2.

The belt stretching member F4 is configured so as to stretch the heat-resistant belt F3 in the tangential line direction of the heat fixing roller F1 in a state that the recording medium F5 does not pass through the fixing nip part. When the fixing pressure is large at the initial position at which the recording medium F5 enters the fixing nip part, there may be the case where the entry is not smoothly performed and fixed in a state that a tip of the recording medium F5 is folded. However, when the belt stretching member F4 is configured so as to stretch the heat-resistant belt F3 in the tangential line direction of the heat fixing roller F1 in this manner, an introduction port part of the recording medium F5 where the entry of the recording medium F5 is smoothly performed can be formed, whereby it becomes possible to make the recording medium F5 stably enter the fixing nip part.

The belt stretching member F4 is a substantially semicircular belt sliding member which is fit by insertion into the heat-resistant belt F3 to impart a tension f to the heat-resistant belt F3 working together with the pressure roller F2 (the heat-resistant belt F3 slides on the belt stretching member F4). This belt stretching member F4 is disposed at a position at which the heat-resistant belt F3 is wound on the side of the heat fixing roller F1 relative to a tangential line L of the press part between the heat fixing roller F1 and the pressure roller F2 to form a nip. A protruding wall F4a is provided by protruding in one end or both ends of the axial direction of the belt stretching member F4. In the case where the heat-resistant belt F3 leans on one side of the end of the axial direction, when this heat-resistant belt F3 comes into contact with this protruding wall 4a, the protruding wall F4a regulates leaning on the end of the heat-resistant belt F3. The spring F9 is provided by contraction between the end part on the opposite side to the heat fixing roller F1 of the protruding wall F4a and the frame F7 and positioned when the protruding wall F4a of the belt stretching member F4 is lightly pressed against the heat fixing roller F1, whereby the belt stretching member F4 comes into slide contact with the heat fixing roller F1.

The position at which the belt stretching member F4 is lightly pressed against the heat fixing roller F1 is defined as a nip initial position, and the position at which the pressure roller F2 is pressed against the heat fixing roller F1 is defined as a nip termination position.

In the fixing part F40, when the recording medium F5 on which the unfixed toner image F5a has been formed comes into the fixing nip part from the nip initial position, passes between the heat-resistant belt F3 and the heat fixing roller F1 and gets out from the nip termination position, the unfixed toner image F5a formed on the recording medium F5 is fixed and then discharged in the direction of the tangential line L of the press part of the pressure roller F2 toward the heat fixing roller F1.

The cleaning member F6 is disposed between the pressure roller F2 and the belt stretching member F4.

This cleaning member F6 is one which comes into slide contact with the inner peripheral surface of the heat-resistant belt F3, thereby cleaning up a foreign matter, an abrasive powder and the like on the inner peripheral surface of the heat-resistant belt F3. By cleaning up a foreign matter, an abrasive powder and the like in this way, the cleaning member F6 refreshes the heat-resistant F3 to eliminate unstableness factors in a coefficient of friction. Also, the belt stretching member F4 is configured to include a recess part F4f, thereby containing the foreign matter and abrasive powder and the like removed from the heat-resistant belt F3 therein.

The fixing part P40 also has a removal blade (removal unit) F12 for, after fixing the toner image F5a onto the recording medium F5, removing the insulating liquid deposited (remained) on the surface of the heat fixing roller F1. This removal blade F12 is able to remove the insulating liquid and also to simultaneously remove the toner or the like moved onto the heat fixing roller F1 during the course of fixing.

For the purpose of stretching the heat-resistant belt F3 by the pressure roller F2 and the belt stretching member F4 to stably drive it by the pressure roller F2, the coefficient of friction between the pressure roller F2 and the heat-resistant belt F3 may be set up larger than the coefficient of friction between the belt stretching member F4 and the heat-resistant belt F3. However, there may be the case where the coefficient of friction becomes unstable due to the penetration of a foreign matter between the heat-resistant belt F3 and the pressure roller F2 or between the heat-resistant belt F3 and the belt stretching member F4, abrasion in the contact part between the heat-resistant belt F3 or the pressure roller F2 and the belt stretching member F4, and the like.

Then, a winding angle between the pressure roller F2 and the heat-resistant belt F3 is set up smaller than a winding angle between the belt stretching member F4 and the heat-resistant belt F3, or a diameter of the pressure roller F2 is set up smaller than a diameter of the belt stretching member F4. According to this, a length at which the heat-resistant belt F3 slides on the belt stretching member F4 becomes short, unstableness factors against a change with time, disturbance and the like can be avoided, and it becomes possible to stably drive the heat-resistant belt F3 by the pressure roller F2.

Specifically, the heat (fixing temperature) to be added by the heat fixing roller F1 is preferably from 80 to 160° C., more preferably from 100 to 150° C., and further preferably from 100 to 140° C.

While the invention has been described on the basis of preferred embodiments, it should not be construed that the invention is limited thereto.

For example, it should not be construed that the liquid developer of the invention is limited to those to be applied to the foregoing image forming apparatus.

Also, it should not be construed that the liquid developer of the invention is limited to those to be manufactured by the foregoing manufacturing method.

In the foregoing embodiments, while the liquid developer prepared by obtaining an aqueous emulsion and adding an electrolyte to the aqueous emulsion to obtain an associated particle has been described, it should not be construed that the invention is limited thereto. For example, the associated particle may be one prepared by employing an emulsion polymerization association method for dispersing a coloring agent, a monomer, a surfactant and a polymerization initiator in an aqueous liquid, preparing an aqueous emulsion by emulsion polymerization and adding an electrolyte to the aqueous emulsion to achieve association, or maybe one prepared by spray drying the obtained aqueous emulsion to obtain an associated particle.

### EXAMPLES

### (1) Synthesis of Resin:

### Linear Polyester Resin: PES1

A 50-L reactor was charged with raw materials of acid and alcohol components, a catalyst and the like having the following composition, and the mixture was allowed to react at 210° C. for 12 hours at atmospheric pressure under a nitrogen gas stream. Thereafter, the pressure was successively reduced, and the reaction was continued at 10 mmHg. The reaction was traced by a softening temperature according to ASTM E28-517, and at a point of time when the softening temperature reached 95° C., the reaction was completed.
Terephthalic acid: 79.7 parts by weight
Isophthalic acid: 53.1 parts by weight
Ethylene glycol: 28.6 parts by weight
Neopentyl glycol: 48.0 parts by weight
Tetrabutyl titanate: 1.0 part by weight

The obtained polymer (PES1) was a colorless solid and had an acid value of 10.0, a glass transition point (Tg) of 55° C. and a softening point (T1/2) of 107° C.

Also, its weight average molecular weight was measured using a GPC analyzer (HLC-8120GPC, manufactured by Tosoh Corporation) and using, as a separation column, a combination of TSK-GEL G5000HXL, G4000HXL, G3000HXL and G2000HXL, all of which are manufactured by Tosoh Corporation, with, as a solvent, tetrahydrofuran having a concentration of 0.5% by mass at a column temperature of 40° C. and at a flow rate of 1 mL/min through a 0.2-μm filter, from which was then determined a molecular weight as reduced into standard polystyrene. As a result, the weight average molecular weight was found to be 7,740.

### Linear Polyester Resin: PES2

A 50-L reactor was charged with raw materials of acid and alcohol components, a catalyst and the like having the following composition, and the mixture was allowed to react at 210° C. for 11 hours at atmospheric pressure under a nitrogen gas stream. Thereafter, the pressure was successively reduced, and the reaction was continued at 10 mmHg. The reaction was traced by a softening temperature according to ASTM E28-517, and at a point of time when the softening temperature reached 87° C., the reaction was completed.
Terephthalic acid: 53.1 parts by weight
Isophthalic acid: 79.7 parts by weight
Ethylene glycol: 26.0 parts by weight
Neopentyl glycol: 43.7 parts by weight
Tetrabutyl titanate: 1.0 part by weight

The obtained polymer (PES2) was a colorless solid and had an acid value of 10.0, a glass transition point (Tg) of 46° C. and a softening point (T1/2) of 95° C. Also, it had a weight average molecular weight of 5,200.

### Branched Polyester Resin: PES3

A 50-L reactor was charged with raw materials of acid and alcohol components, a catalyst and the like having the following composition, and the mixture was allowed to react at 240° C. for 12 hours at atmospheric pressure under a nitrogen gas stream. Thereafter, the pressure was successively reduced, and the reaction was continued at 10 mmHg. The reaction was traced by a softening temperature according to ASTM E28-517, and at a point of time when the softening temperature reached 159° C., the reaction was completed.
Terephthalic acid: 19.4 parts by weight
Isophthalic acid: 90.7 parts by weight
Adipic acid: 17.1 parts by weight
Ethylene glycol: 25.4 parts by weight
Neopentyl glycol: 42.6 parts by weight
Tetrabutyl titanate: 1.0 part by weight
   EPICLON 830 (Bisphenol F type epoxy resin having an epoxy equivalent of 170 (g/eq), manufactured by DIC Corporation):
   3.0 parts by weight
      CARJURA E (Alkyl glycidyl ester having an epoxy equivalent of 250 (g/eq), manufactured by Shell Japan Ltd.):
   1.0 part by weight

The obtained polymer (PES3) was a colorless solid and had an acid value of 9.8, a glass transition point (Tg) of 40° C. and a softening point (T1/2) of 176° C. Also, it had a weight average molecular weight of 17,600.

### (2) Production of Liquid Developer:

### Example 1

### Preparation of Fatty Acid Monoester-Containing Liquid:

A fatty acid monoester-containing liquid constituting an insulating liquid was prepared in the following manner.

First of all, crude soybean oil was purified in the following manner, thereby obtaining purified soybean oil.

First, crude soybean oil was crudely purified by a low-temperature crystallization method using, as a solvent, methanol, diethyl ether, petroleum ether, acetone, etc.

Next, 300 parts by volume of the crudely purified crude soybean oil (first crudely purified oil) was charged in a flask, and thereafter, 100 parts by volume of boiling water was poured into the flask, followed by corking the flask.

Next, the flask was shaken to mix the foregoing crude soybean oil (first crudely purified oil) and boiling water with each other.

Next, the flask was allowed to stand until the mixed liquid in the flask had been separated into three layers.

After confirming complete separation, the flask was moved into a refrigerator and allowed to stand for 24 hours.

Thereafter, a non-frozen component was transferred into a separate flask.

The foregoing operations were again repeated for this non-frozen component, and the obtained non-frozen component was taken out to obtain a crude oil and fat (second crudely purified oil).

Next, 100 parts by volume of the thus obtained crude oil and fat (second crudely purified oil) and 35 parts by volume of activated clay composed mainly of hydrated aluminum silicate were mixed and stirred in a flask.

Next, the obtained mixture was stored under a pressure (0.18 MPa) for 48 hours, thereby completely precipitating the activated clay.

Thereafter, the precipitate was removed to obtain purified soybean oil (hereinafter simply referred to as “soybean oil”). The soybean oil contained a fatty acid glyceride composed mainly of linoleic acid, and the content of an unsaturated fatty acid glyceride in the soybean oil was 98% by weight. The content of the linoleic acid component was 53% by mole of the whole of fatty acid components.

Next, the obtained soybean oil was subjected to an ester exchange reaction with methanol, and glycerin formed by this reaction was removed to obtain a liquid composed mainly of a fatty acid monoester. Furthermore, this liquid was purified to obtain a soybean oil fatty acid methyl having the content of fatty acid monoester of 99.9% by weight or more. The thus obtained fatty acid monoester was mainly constituted of an unsaturated fatty acid monoester such as methyl oleate, methyl linolate and methyl α-linoleate and a saturated fatty acid monoester such as methyl palmitate and methyl stearate, and the unsaturated fatty acid monoester accounted for 84% of these fatty acid monoesters. A viscosity of the soybean oil fatty acid methyl as measured at 25° C. according to JIS Z8809 using a vibration type viscometer was 3.0 mPa·s.

### Preparation of Coloring Agent Master:

First of all, a mixture (mass ratio: 50/50) of the thus obtained polyester resin PES1 and a cyan based pigment (Pigment Blue 15:3, manufactured by Dainichiseika Color & Chemicals Mfg. Co., Ltd.) as a coloring agent was prepared. These respective components were mixed using a 20L type Henschel mixer.

Next, this mixture was kneaded at a temperature set up just above the resin softening temperature using a twin-screw kneading extruder. A kneaded material extruded from an extrusion port of the twin-screw kneading extruder was cooled.

The thus cooled kneaded material was coarsely pulverized to prepare a master batch powder having an average particle size of not more than 1.0 mm. A hummer mill was used for coarsely pulverizing the kneaded material.

### Preparation of Resin Liquid:

70 parts by weight of the foregoing polyester resin PES1 and 81.8 parts by weight of methyl ethyl ketone were added and mixed for dissolution by a T.K. ROBOMICS (disper blade, manufactured by Primix Co., Ltd.); 30 parts by weight of the foregoing coloring agent master batch powder was further added; and the mixture was further stirred to prepare a pigment resin solution. In this solution, the pigment was uniformly finely dispersed.

Next, 1N ammonia water was added to the resin solution in the flask in a molar equivalent ratio of 1.1 relative to the acid value which the foregoing polyester resin had. Thereafter, 160 parts by weight of deionized water was added dropwise while keeping stirring. The temperature of the solution in the flask was adjusted at 25 to 30° C., thereby achieving phase inversion emulsification. At that time, the emulsification size was 0.12 μm. Furthermore, 40 parts by weight of deionized water was added dropwise to obtain an emulsion in which a dispersoid containing the colored particle and the polyester resin was dispersed.

### Preparation of United Particle:

In a cylindrical 2-L separable flask equipped with a maxblend stirring blade, 382 parts by weight of the foregoing resin liquid was charged, and 2.6 parts by weight of EMAL 0 (manufactured by Kao Corporation) as an anion type emulsifier which had been diluted with 30 parts by weight of deionized water was added while thoroughly stirring by a three-one motor, manufactured by Shinto Scientific Co., Ltd. at a number of revolutions of 210 rpm (peripheral speed: 0.71 m/s). Thereafter, 62 parts by weight of a 3.5% ammonium sulfate aqueous solution was added dropwise while keeping the aqueous emulsion at a temperature of 25° C. to 30° C.

Thereafter, the particle was grown to an extent that the particle size reached 2.8 μm while gradually dropping the number of revolutions and measuring the particle size. At that time, the number of revolutions of stirring was 150 rpm (peripheral speed: 0.54 m/s). Thereafter, the number of revolutions was returned to 210 rpm, and the stirring was continued for about 30 minutes. Thereafter, 400 parts by weight of deionized water was added as stopping water to obtain a united particle dispersion.

For the obtained united particle dispersion, the organic solvent was evaporated off in vacuo using an evaporator, and the residue was washed with ion exchanged water, rinsed and filtered, followed by drying by warm air at a temperature not higher than Tg to obtain a united particle.

The average particle size of the respective particles in the respective Examples and Comparative Example is a volume average particle size, and these average particle size and particle size distribution of the particles were measured by a Mastersizer 2000 particle size analyzer (manufactured by Malvern Instruments Ltd.).

### Preparation of Liquid Developer:

100 parts by weight of the thus obtained united particle, 150 parts by weight of the soybean oil fatty acid methyl, 2.5 parts by weight of a polyamine fatty acid polycondensate (a trade name: SOLSPERSE 13900, manufactured by Lubrizol Japan Ltd.) as a dispersant and 1.25 parts by weight of aluminum stearate (manufactured by NOF Corporation) were charged in a ceramic pot, and zirconia balls (ball diameter: 3 mm) were further charged in the ceramic pot in a filling factor of 30%. Dispersion was performed at a number of revolutions of 120 rpm for 100 hours by a potable pot mill to obtain a toner dispersion (dispersion step).

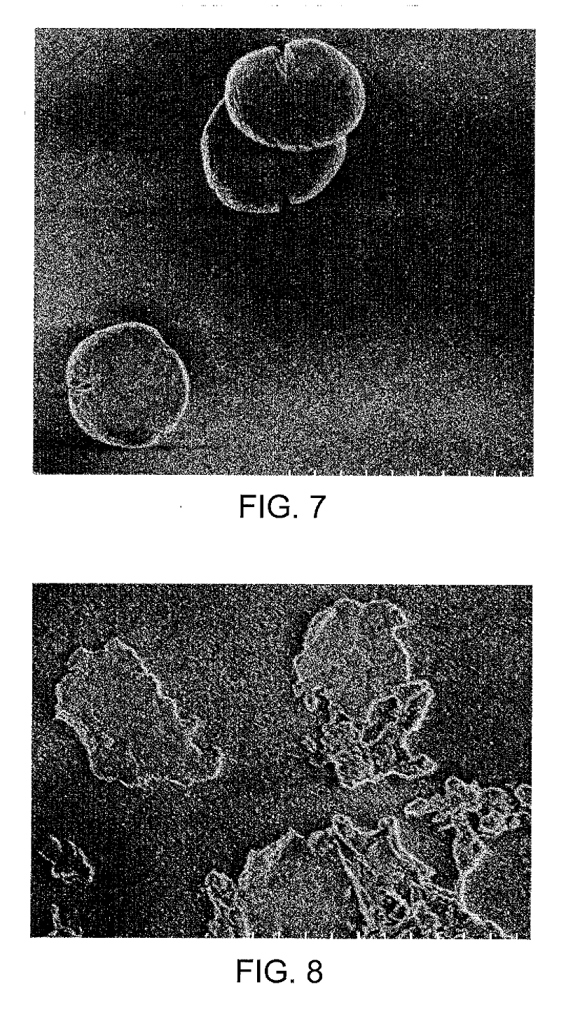

After completion of dispersion, 250 parts by weight of rapeseed oil (a trade name: HIGH OLEIC RAPESEED OIL, manufactured by The Nisshin OiliO Group, Ltd.) was charged, thereby dispersing the toner particle therein. Dispersion was performed for 24 hours upon being charged with zirconia balls having a ball diameter of 1 mm. There was thus obtained a liquid developer. A photograph of the toner particle to be contained in the obtained liquid developer by a scanning electron microscope (SEM) is shown in FIG. 7.

### Examples 2 to 8

Liquid developers were produced in the same manner as in the foregoing Example 1, except for changing the ball diameter of the zirconia balls and the dispersion time in the dispersion step as shown in Table 1.

### Example 9

A liquid developer was produced in the same manner as in the foregoing Example 1, except for using the foregoing synthesized PES2 as the polyester resin.

### Example 10

A liquid developer was produced in the same manner as in the foregoing Example 1, except for using a mixture of PES1 and PES3 in a weight ratio of 1/4 as the polyester resin.

### Example 11

A liquid developer was produced in the same manner as in the foregoing Example 1, except for using a mixture of PES2 and PES3 in a weight ratio of 1/6 as the polyester resin.

### Example 12

A liquid developer corresponding to each color was produced in the same manner as in the foregoing Example 1, except for using soybean oil (manufactured by The Nisshin OiliO Group, Ltd.) in place of the rapeseed oil.

### Example 13

Crude rapeseed oil was purified in the same operations as in the soybean oil in Example 1, thereby obtaining purified rapeseed oil (hereinafter simply referred to as “rapeseed oil”). The rapeseed oil contained a fatty acid glyceride composed mainly of oleic acid, and the content of an unsaturated fatty acid glyceride in the rapeseed oil was 98% by weight. The contents of the oleic acid component and the linoleic acid component were 52% by mole and 24% by mole, respectively of the whole of fatty acid components.

Next, a part of this rapeseed oil was subjected to an ester exchange reaction with methanol, and glycerin formed by this reaction was removed to obtain a liquid composed mainly of a fatty acid monoester. Furthermore, this liquid was purified to obtain a rapeseed oil fatty acid methyl having the content of fatty acid monoester of 99.9% by weight or more.

Then, a liquid developer corresponding to each color was produced in the same manner as in the foregoing Example 1, except for using the rapeseed oil fatty acid methyl in place of the soybean oil fatty acid methyl and using a liquid paraffin (a trade name: COSMO WHITE P-60, manufactured by Cosmo Oil Co., Ltd.) in place of the rape seed oil as the insulating liquid.

### Comparative Example

First of all, 85 parts by weight of the polyester resin PES1 and 15 parts by weight of a cyan based pigment (Pigment Blue 15:3, manufactured by Dainichiseika Color & Chemicals Mfg. Co., Ltd.) as a coloring agent were prepared. These respective components were mixed using a 20L type Henschel mixer to obtain a raw material for producing a toner.

Next, this raw material (mixture) was kneaded in the same manner as in Example 1 using a twin-screw kneading extruder. A kneaded material extruded from an extrusion port of the twin-screw kneading extruder was cooled.

The thus cooled kneaded material was coarsely pulverized to prepare a powder (coarsely pulverized material) having an average particle size of not more than 1.0 mm. A hummer mill was used for coarsely pulverizing the kneaded material.

Next, 100 parts by weight of the thus obtained coarsely pulverized material, 150 parts by weight of the soybean oil fatty acid methyl obtained in the same manner as in the foregoing Example 1, 2.5 parts by weight of a polyamine fatty acid polycondensate (a trade name: SOLSPERSE 13900, manufactured by Lubrizol Japan Ltd.) as a dispersant and 225 parts by weight of rapeseed oil (a trade name: HIGH OLEIC RAPESEED OIL, manufactured by The Nisshin OiliO Group, Ltd.) were prepared.

The foregoing respective components were charged in a ball mill (ball diameter: 10.0 mm) and wet pulverized for 200 hours to obtain a liquid developer. A toner particle in the obtained liquid developer was observed using a scanning electron microscope (SEM). As a result, the toner particle was uneven in the shape and was not shaped in a disc form. A photograph by this SEM is shown in FIG. 8.

As to the foregoing respective Examples and Comparative Example, production conditions and physical properties of the liquid developers are shown in Table 1.

TABLE 1

| | | | Insulating liquid | | | | | |
|---|---|---|---|---|---|---|---|---|
| | | | Liquid | | Liquid | | | |
| | | | used for dispersion (liquid | | used for dispersion (liquid | | | |
| | | | used for wet pulverization | | used for wet pulverization | | | Dispersion time |
| | Resin material | | in Comparative Example) | | in Comparative Example) | | | (wet pulverization |
| | | Glass transition | | Content in | | Content in | Ball | time in |
| | | point/softening | | insulating | | insulating liquid | diameter | Comparative |
| | Kind | point (° C.) | Kind | liquid (wt %) | Kind | (wt %) | (mm) | Example) (hr) |
| Example 1 | PES1 | 55/107 | Soybean oil fatty | 37.5 | Rapeseed oil | 62.5 | 3 | 100 |
| | | | acid methyl | | | | | |
| Example 2 | PES1 | 55/107 | Soybean oil fatty | 37.5 | Rapeseed oil | 62.5 | 3 | 144 |
| | | | acid methyl | | | | | |
| Example 3 | PES1 | 55/107 | Soybean oil fatty | 37.5 | Rapeseed oil | 62.5 | 3 | 200 |
| | | | acid methyl | | | | | |
| Example 4 | PES1 | 55/107 | Soybean oil fatty | 37.5 | Rapeseed oil | 62.5 | 2 | 100 |
| | | | acid methyl | | | | | |
| Example 5 | PES1 | 55/107 | Soybean oil fatty | 37.5 | Rapeseed oil | 62.5 | 1 | 100 |
| | | | acid methyl | | | | | |
| Example 6 | PES1 | 55/107 | Soybean oil fatty | 37.5 | Rapeseed oil | 62.5 | 3 | 75 |
| | | | acid methyl | | | | | |
| Example 7 | PES1 | 55/107 | Soybean oil fatty | 37.5 | Rapeseed oil | 62.5 | 3 | 50 |
| | | | acid methyl | | | | | |
| Example 8 | PES1 | 55/107 | Soybean oil fatty | 37.5 | Rapeseed oil | 62.5 | 3 | 24 |
| | | | acid methyl | | | | | |
| Example 9 | PES2 | 46/95 | Soybean oil fatty | 37.5 | Rapeseed oil | 62.5 | 3 | 100 |
| | | | acid methyl | | | | | |
| Example 10 | PES1 + PES2 | 43/162 | Soybean oil fatty | 37.5 | Rapeseed oil | 62.5 | 3 | 100 |
| | | | acid methyl | | | | | |
| Example 11 | PES2 + PES3 | 41/160 | Soybean oil fatty | 37.5 | Rapeseed oil | 62.5 | 3 | 100 |
| | | | acid methyl | | | | | |
| Example 12 | PES1 | 55/107 | Soybean oil fatty | 37.5 | Soybean oil | 62.5 | 3 | 100 |
| | | | acid methyl | | | | | |
| Example 13 | PES1 | 55/107 | Rapeseed oil fatty | 37.5 | Liquid paraffin | 62.5 | 3 | 100 |
| | | | acid methyl | | | | | |
| Comparative | PES1 | 55/107 | Soybean oil fatty | 40 | Rapeseed oil | 60 | 10 | 200 |
| Example | | | acid methyl | | | | | |

### (3) Evaluation:

Each of the thus obtained liquid developers was evaluated in the following manners.

### (3-1) Fix Level:

An image with a prescribed pattern by each of the liquid developers obtained in the foregoing respective Examples and Comparative Example was formed on recording paper (AURORA COAT PAPER, manufactured by Nippon Paper Industries Co., Ltd.) using the image forming apparatus as illustrated in FIG. 3. Thereafter, heat fixing was performed at a temperature of a heat fixing roller set up at 120° C. using the fixing device as illustrated in FIG. 6.

Thereafter, after confirming a non-offset area, the fixed image on the recording paper was rubbed twice by an eraser (abrasive eraser “LION 261-11”, manufactured by Lion Office Products Corp) under a press load of 1.2 kgf; and a retention ratio of image density was measured by X-RITE MODEL 404 (manufactured by X-Rite Inc) and evaluated on five grades according to the following criteria.

A: The retention ratio of image density is 95% or more (very good).

B: The retention ratio of image density is 90% or more and less than 95% (good).

C: The retention ratio of image density is 80% or more and less than 90% (moderate).

D: The retention ratio of image density is 70% or more and less than 80% (slightly poor).

E: The retention ratio of image density is less than 70% (very poor).

### (3-2) Fixability:

The toners obtained in the foregoing respective Examples and Comparative Example were evaluated with respect to an area with good fixability and low-temperature fixability in the following manner.

First of all, an image forming apparatus having the same configuration as that illustrated in FIG. 3, except for not having the fixing device was prepared. Using this image forming apparatus, an unfixed image sample in which a monochromic toner image was transferred onto a recording medium (AURORA COAT PAPER, manufactured by Nippon Paper Industries Co., Ltd.) was collected. The sample to be collected was adjusted such that the solid deposition amount was 0.12 mg/cm² in terms of solids content.

Next, the recording medium onto which the foregoing unfixed toner image had been transferred was introduced into the inside of the fixing device as illustrated in FIG. 6 in a state that the surface temperature of the fixing roller of the fixing device constituting the image forming apparatus was set up at a prescribed temperature, thereby fixing the toner image on the recording medium. Then, the presence or absence of the generation of offset after fixing was visually observed. In this fixing device, fixing was set up at a rate of 50 sheets per minute (a number of sheets of an A-4 size passing through the nip part) The temperature on the surface of the fixing roller to be set up was successively changed within the range of from 60° C. to 160° C.; the presence or absence of the generation of offset at each temperature was confirmed; and evaluation was made on four grades according to the following criteria while defining a maximum temperature at which the low-temperature offset was generated as a low-temperature offset-generating temperature.

A: The low-temperature offset-generating temperature is lower than 100° C.

B: The low-temperature offset-generating temperature is 100° C. or higher and lower than 110° C.

C: The low-temperature offset-generating temperature is 110° C. or higher and lower than 130° C.

D: The low-temperature offset-generating temperature is 130° C. or higher.

### (3-3) Evaluation of Gloss of Formed Toner Image:

An image by each of the liquid developers obtained in the foregoing respective Examples and Comparative Example was formed on recording paper (AURORA COAT PAPER, manufactured by Nippon Paper Industries Co., Ltd.) using the image forming apparatus as illustrated in FIG. 3 while adjusting the deposition amount at 0.24 mg/cm² in terms of solids content. Thereafter, heat fixing was performed at a temperature of a heat fixing roller set up at 130° C. using the fixing device as illustrated in FIG. 6.

As to the thus obtained image on the recording paper, the printed area was measured for gloss using a gloss meter (GM-26D, manufactured by Murakami Color Research Laboratory Co., Ltd.); and evaluation was made on four grades according to the following criteria.

A: A difference in gloss between the paper and the solid part is less than 5%.

B: A difference in gloss between the paper and the solid part is 5% or more and less than 15%.

C: A difference in gloss between the paper and the solid part is 15% or more and less than 25%.

D: A difference in gloss between the paper and the solid part is 25% or more.

These results are shown in Table 2 along with the particle size distribution, the average particle size in the major axis direction and the minor axis direction and so on. As to the measurement of the average particle size in each of the major axis direction and minor axis direction of the toner particle, unfixed prints on the paper were thoroughly dried at room temperature and then observed by SEM (Hitachi S-4800). As to the major axis, planarly deposited particles were chosen, and an average of those between the longest axis and the shortest axis was employed. As to the minor axis, particles positioned in the vertical direction were chosen, and the thickness thereof was measured. Each 100 particles were measured and arithmetically averaged.

TABLE 2

| | Toner particle | | | | | | | | |
|---|---|---|---|---|---|---|---|---|---|
| | Particle size | Tg of solid in | | Average diameter | Average diameter | | | | |
| | distribution | developer | | X in major axis | Y in minor axis | | | Low-temperature | |
| | Dv/Dh | (° C.) | Shape | direction (μm) | direction (μm) | Y/X | Fix level | fixability | Gloss |
| Example 1 | 1.16 | 35.0 | Disc | 2.30 | 1.02 | 0.45 | A | A | A |
| Example 2 | 1.19 | 34.4 | Disc | 2.70 | 0.99 | 0.37 | A | A | A |
| Example 3 | 1.20 | 34.3 | Disc | 3.02 | 0.90 | 0.30 | A | A | A |
| Example 4 | 1.16 | 35.1 | Disc | 2.55 | 1.05 | 0.41 | A | A | A |
| Example 5 | 1.17 | 35.8 | Disc | 2.40 | 1.10 | 0.46 | B | B | B |
| Example 6 | 1.24 | 36.3 | Disc | 2.32 | 1.22 | 0.52 | B | B | B |
| Example 7 | 1.26 | 36.6 | Disc | 2.25 | 1.32 | 0.59 | B | B | B |
| Example 8 | 1.27 | 37.7 | Disc | 2.27 | 1.58 | 0.69 | C | C | C |
| Example 9 | 1.24 | 26.3 | Disc | 3.74 | 0.37 | 0.10 | B | A | A |
| Example 10 | 1.26 | 25.6 | Disc | 3.85 | 0.36 | 0.09 | B | A | A |
| Example 11 | 1.27 | 24.7 | Disc | 3.91 | 0.34 | 0.09 | B | A | A |
| Example 12 | 1.16 | 37.0 | Disc | 2.25 | 1.02 | 0.45 | A | C | A |
| Example 13 | 1.16 | 35.5 | Disc | 2.30 | 1.00 | 0.43 | B | B | B |
| Comparative | 1.85 | 39.0 | Uneven | 3.50 | 0.11 | 0.03 | E | D | C |
| Example | | | | | | | | | |

As is clear from Table 2, the liquid developer of the invention is adapted for low-temperature fixing, and even in the case where fixing was performed at a relatively low temperature, the formed toner image was firmly fixed onto the recording medium. Also, the liquid developer of the invention was one capable of forming an image with excellent gloss. Also, the image formed by the liquid developer of the invention was excellent in long-term stability. On the other hand, in the comparative liquid developer, satisfactory results could not be obtained.

The entire disclosure of Japanese Patent Application No. 2007-224842, filed Aug. 30, 2007 is expressly incorporated by reference herein.

What is claimed is:

1. A liquid developer comprising
an insulating liquid containing a fatty acid monoester; and
a toner particle constituted mainly of a resin material,
the main toner particle being shaped in a disc form.

2. The liquid developer according to claim 1, wherein when an average diameter in the major axis direction and an average diameter in the minor axis direction of the toner particle are defined as X (μm) and Y (μm), respectively, a relationship of (0.05≦Y/X≦0.7) is satisfied.

3. The liquid developer according to claim 1, wherein the average diameter in the major axis direction of the toner particle is from 1 to 10 μm.

4. The liquid developer according to claim 1, wherein the average diameter in the minor axis direction of the toner particle is from 0.1 to 4 μm.

5. The liquid developer according to claim 1, wherein the fatty acid monoester is one containing a fatty acid having from 8 to 22 carbon atoms as a fatty acid component.

6. The liquid developer according to claim 1, wherein the fatty acid monoester is one containing an alcohol component having from 1 to 4 carbon atoms.

7. The liquid developer according to claim 1, wherein the content of the fatty acid monoester in the insulating liquid is from 1.0 to 50% by weight.

8. The liquid developer according to claim 1, wherein the insulating liquid is one containing a fatty acid triglyceride.

9. The liquid developer according to claim 1, wherein a solid obtained by removing the insulating liquid has a Tg measured by DSC of from 15 to 35° C.

10. The liquid developer according to claim 1, wherein the resin material is one containing a polyester resin.

11. An image forming apparatus comprising
plural development parts for forming a monochromic image corresponding to each color using plural liquid developers having a different color;
an intermediate transfer part for forming an intermediate transferred image to be formed by successively transferring the plural monochromic images formed in the plural development parts and superimposing the plural transferred monochromic images;
a secondary transfer part for transferring the intermediate transferred image onto a recording medium to form an unfixed color image on the recording medium; and
a fixing part for fixing the unfixed color image onto the recording medium,
the liquid developer including an insulating liquid containing a fatty acid monoester and
a toner particle constituted mainly of a resin material, and
the toner particle having a transverse cross section in a substantially elliptical shape and a longitudinal cross section in a substantially circular shape.
